(19) United States
(12) Patent Application Publication
(10) Pub. No.: US 2022/0132839 A1
(43) Pub. Date: May 5, 2022

(54) MOSQUITO ATTRACTANT COMPOSITIONS

(71) Applicant: UNIVERSITY OF WASHINGTON, Seattle, WA (US)

(72) Inventors: Jeffrey A. Riffell, Seattle, WA (US); Chloé Lahondère, Seattle, WA (US); Clément Vinauger, Seattle, WA (US)

(73) Assignee: UNIVERSITY OF WASHINGTON, Seattle, WA (US)

(21) Appl. No.: 17/431,869

(22) PCT Filed: Feb. 20, 2020
(86) PCT No.: PCT/US2020/019107

§ 371 Date: Aug. 18, 2021

Related U.S. Application Data
(60) Provisional application No. 62/808,710, filed on Feb. 21, 2019.

(51) Int. Cl. A01N 31/02; A01N 43/08; A01N 31/04; A01P 17/00; A01P 19/00; A01M 29/12; A01M 1/20

(52) U.S. Cl. CPC A01N 31/02; A01N 43/08; A01N 31/04; A01M 1/2016; A01P 19/00; A01M 29/12; A01P 17/00

(57) ABSTRACT

Mosquito attractant composition for attracting a mosquito to a pre-determined location. The composition includes a combination of nonanal and lilac aldehydes.

### CROSS-REFERENCE TO RELATED APPLICATION

This application claims the benefit of U.S. Application No. 62/808,710, filed Feb. 21, 2019, expressly incorporated herein by reference in its entirety.

### STATEMENT OF GOVERNMENT LICENSE RIGHTS

This invention was made with government support under Grant No. FA9550-16-1-0167, awarded by the Air Force Office of Scientific Research, and Grant No. IOS-1354159, awarded by the National Science Foundation. The government has certain rights in the invention.

### BACKGROUND OF THE INVENTION

Mosquitoes are important vectors of disease, such as dengue, malaria or Zika, and are considered one of the deadliest animal on earth. For this reason, research has largely focused on mosquito-host interactions, and in particular, the mosquito's sensory responses to those hosts. Nectar feeding is one such aspect of mosquito sensory biology that has received comparatively less attention, despite being an excellent system in which to probe the neural bases of behavior. For instance, nectar- and sugar-feeding is critically important for both male and female mosquitoes, serving to increase their lifespan, survival rate, and reproduction, and for males, it is required for survival.

Mosquitoes are attracted to, and feed on, a variety of plant nectar sources, including those from flowers. Although most examples of mosquito-plant interactions have shown that mosquitoes contribute little in reproductive services to the plant, there are examples of mosquitoes being potential pollinators. However, few studies have identified the floral cues that serve to attract and mediate these decisions by the mosquitoes and how these behaviors influence pollination.

The association between the Platanthera obtusata orchid and Aedes mosquitoes is one of the few examples that shows mosquitoes as effective pollinators and thus provides investigators a unique opportunity to identify the sensory mechanisms that help mosquitoes locate sources of nectar. The genus Platanthera has many different orchid species having diverse morphologies and specialized associations with certain pollinators, with P. obtusata being an exemplar with its association with mosquitoes. Although mosquito visitation has been described in this species, the cues that attract mosquitoes to the flowers, and the importance of mosquito visitation for orchid pollination, are unknown.

Despite the advance in the development of compositions and methods for controlling mosquito populations, a need exists for improved compositions and methods.

### SUMMARY OF THE INVENTION

In one aspect, the present invention provides mosquito attractant compositions and methods for their use as a lure for attracting mosquitos. In other aspects, mosquito repellent compositions and methods for their use to repel mosquitos are provided.

In one aspect of the invention, compositions are provided that include nonanal and lilac aldehydes. In one embodiment, the composition comprises nonanal and lilac aldehydes, wherein the ratio of nonanal to lilac aldehydes is from about 1:1 to about 100:1 by weight based on the total weight of nonanal and lilac aldehydes. In another embodiment, the composition comprises nonanal, lilac aldehydes, and a solvent carrier. In a further embodiment, the composition comprises nonanal, lilac aldehydes, and a substrate.

In certain embodiments, the lilac aldehydes are a mixture of lilac aldehyde B, lilac aldehyde C, and lilac aldehyde D.

In certain embodiments, the compositions further include one or more of heptanal, octanal, 1-octanol, α-pinene, camphene, β-pinene, β-myrcene, D-limonene, eucalyptol, linalool, myrtenol, and benzaldehyde.

In certain embodiments, the compositions are attractant formulations wherein the ratio of nonanal to lilac aldehydes is about 100:1 based on the amount (mass) of nonanal and lilac aldehydes in the composition. In other of these embodiments, the ratio of nonanal to lilac aldehydes is about 1:1 based on the amount (mass) of nonanal and lilac aldehydes in the composition.

In other embodiments, the compositions are repellent formulations wherein the ratio of lilac aldehydes to nonanal is about 6:1 based on the amount (mass) of lilac aldehydes and nonanal in the composition.

In other aspects, the invention provides the use of certain of the compositions as a mosquito attractant and the use of certain other of the compositions as a mosquito repellent. Methods for attracting and repelling mosquitoes to a pre-determined location are also provided.

In further aspects, the invention provides dispensers for attracting mosquitoes and dispensers for repelling mosquitoes. Dispensers for attracting mosquitoes include the attractant formulations described herein and dispensers for repelling mosquitoes include the repellent formulations described herein. The dispensers include a housing containing the desired composition, and the housing is adapted to release the composition over time into an environment in the vicinity of the dispenser.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIG. 1 illustrates the distribution of the mosquito species found in the field with pollinia (pie chart; numbers in legend denote the number of mosquitoes with pollinia).

FIG. 2 compares insect visitations (barplot; % insect visitation, calculated by the total number of insect visits to P. obtusata). Both males (dark grey bars) and females (white bars) of different mosquito species visited the plants. Black-legged mosquitoes were pre-dominantly Ae. communis, and striped legged were Ae. increpitus. Numbers above the bars indicate the number of individuals observed with pollinia.

FIG. 3 compares fruit to flower ratio for bagged (using Organza bags around P. obtusata plants to prevent pollinator visitation), unbagged, self-crossed, out-crossed plants, and plants in the enclosure. Bagged and self-pollinated plants produced similar fruit-to-flower ratios (0.11±0.04, 0.12±0.06, respectively; Mann-Whitney Test: p=0.99), but were significantly lower than the unbagged plants (0.89±0.03; Mann-Whitney Test, p<0.001). Although fruit weight did not differ between treatments (Student's t-test, p=0.082), bagged plants produced significantly less viable seeds per fruit per flower than unbagged plants (Wilcoxon rank sum test, p<0.05). Letters above bars show statistical differences between experimental conditions (Mann-Whitney Test: p<0.05). Bars are the mean±SEM (n=8-20 plants/treatment).

FIG. 4 is a pie chart of the species of mosquitoes which removed pollinia from the plants in the enclosures (numbers in legend denote the number of mosquitoes with pollinia).

FIGS. 5A-5F are show gas chromatography/mass spectrometry (GCMS) analyses of the floral volatiles emitted by P. obtusata (5A), P. ciliaris (5B) P. stricta (5C), P. dilatata (5D), P. huronensis (5E), and P. yosemitensis (5F). P. obtusata flowers emitted a low emission rate scent that is dominated by aliphatic compounds (including octanal (#7), 1-octanol (#9), and nonanal (#11); 54% of the total emission), whereas the moth-visited species P. dilatata, P. huronensis, and P. stricta emit strong scents dominated by terpenoid compounds (75%, 76% and 97% of the total emission for the three species, respectively), and the butterfly-visited P. ciliaris orchid is dominated by nonanal and limonene (24% and 12% of the total emission respectively). Numbers in the chromatograms correspond to: (1) α-pinene, (2) camphene, (3) benzaldehyde, (4) β-pinene, (5) β-myrcene, (6) octanal, (7) D-limonene, (8) eucalyptol, (9) 1-octanol, (10) (±)linalool, (11) nonanal, (12) lilac aldehydes (D and C isomers), and (13) lilac alcohol.

FIG. 6 is a non-metric multidimensional scaling (NMDS) plot (stress=0.265) of the chemical composition of the scent of all the orchid species presented in B. Each dot represents a sample from a single individual plant collected in the field. The ellipses represent the standard deviation around the centroid of their respective cluster. Differences in scent composition and emission rate are significantly different between species (composition: ANOSIM, R=0.25, p=0.001; emission rate: Student t-tests, p<0.05).

FIGS. 7A-7E show gas chromatogram traces for the P. obtusata (left), P. stricta (middle), and P. huronensis (right) headspaces, with electroantennogram responses to the GC peaks for four mosquito species (Ae. increpitus (7B), Ae. communis (7C), Ae. aegypti (7D), and An. stephensi (7E)) immediately below. Numbers in the chromatograms correspond to: (1) α-pinene, (2) camphene, (3) benzaldehyde, (4) β-pinene, (5) β-myrcene, (6) octanal, (7) D-limonene, (8) eucalyptol, (9) 1-octanol, (10) linalool, (11) nonanal, (12) lilac aldehyde (C, D isomers), and (13) lilac alcohol.

FIG. 8 is a Principal Component Analysis (PCA) plot based on the antennal responses of individual mosquitoes from the different Aedes species to the peaks from the P. obtusata, P. stricta, and P. huronensis scents. Each dot corresponds to the responses of an individual mosquito; shaded areas and dots are coded according to mosquito species and flower scent (P. obtusata; P. stricta; and P. huronensis). Antennal responses to the three tested orchid scents were significantly different from one another (ANOSIM, R=0.137, p<0.01) (n=3-16 mosquitoes per species per floral extract).

FIG. 9 compares behavioral preferences (Preference Index) by snow mosquitoes (Ae. communis and Ae. increpitus), Ae. aegypti, and An. stephensi mosquitoes to the P. obtusata scent and scent mixture, with and without the lilac aldehyde (at the concentration found in the P. obtusata headspace). A y-maze olfactometer was used for the behavioral experiments in which mosquitoes are released and had to fly upwind and choose between two arms carrying the tested compound/mixture or no odorant (control). A preference index (PI) was calculated based on these responses. The plant motif is the positive control (orchid flowers), and the + and − symbols represent the presence or absence of the lilac aldehyde in the stimulus, respectively. Bars are the mean±SEM (n=27-75 mosquitoes/treatment); asterisks denote a significant difference between treatments and the mineral oil (no odor) control (binomial test: p<0.05).

FIG. 10 compares the percentage of nonanal and lilac aldehyde concentrations in the different Platanthera orchid scents, which have 6- to 40-fold higher lilac aldehyde concentrations than P. obtusata.

FIG. 11 compares behavioral preferences (preference index, PI) by Ae. aegypti mosquitoes to scent mixtures containing lilac aldehydes at the concentrations quantified in the different Plathanthera species. Similar to FIG. 9, mosquitoes were released in a y-olfactometer and had to choose between two arms carrying the scent mixture or no odorant (control). Asterisk denotes a significant difference from the mineral oil control (binomial test: p<0.05); number symbol denotes a significant difference from the P. obtusata scent (binomial test:p<0.05).

FIGS. 12A-12D compare mean ΔF/F time traces for LC2 and AM2 glomeruli to P. obtusata (12A) and nonanal (12C) and to P. stricta scent (12B) and lilac aldehyde (12D). The P. obtusata and P. stricta mixtures contain the same concentration of nonanal and other constituents but differ in their lilac aldehyde concentrations. Traces are the mean (n=6-10 mosquitoes); shaded areas denote ±SEM.

FIGS. 13A and 13B compare responses of the LC2 glomerulus (13A) and the AM2 glomerulus (13B) to the different Platanthera orchid mixtures, and the single odorants nonanal and lilac aldehyde. The increasing concentration of lilac aldehyde in the other orchid mixtures caused a significant suppression of LC2 response to the nonanal in the scents (Kruskal-Wallis test: p<0.05), even though nonanal was at the same concentration as in the P. obtusata mixture. The increasing concentration of lilac aldehyde in the other orchid scents caused a significant increase in AM2 responses compared with responses to P. obtusata (Kruskal-Wallis test: p<0.05). Bars are the mean±SEM.

FIGS. 14A-14D compares ΔF/F time traces for the LC2 (14A and 14B) and AM2 (14C and 14D) glomeruli. The preparation was simultaneously stimulated using separate vials of lilac aldehyde and nonanal at different concentrations to create 10 different mixture ratios. For 14A and 14C, each trace is a different ratio of lilac aldehyde to nonanal, ranging from (10⁻² nonanal: 0 lilac aldehyde) to (0 nonanal: 10⁻¹ lilac aldehyde); 10⁻³ to 10⁻¹ lilac aldehyde, and 10⁻² nonanal concentrations were tested (lilac aldehyde concentration shown). For 14B and 14D, same as 14A and 14C, respectively, except tested concentrations were 10⁻³ to 10⁻¹ for lilac aldehyde, and 10⁻³ for nonanal (lilac aldehyde concentration shown) (see FIGS. 15A and 15B).

FIGS. 15A and 15B compare mean ΔF/F during 2 sec. of odor presentation for the LC2 glomerulus (left) and the AM2 glomerulus (right). Bars are coded according to the ratio of lilac aldehyde to nonanal traces in FIGS. 14A and 14C (FIG. 15A). For FIG. 15B, same as FIG. 15A except the concentrations of lilac aldehyde and nonanal in the ratio mixtures correspond to those in FIGS. 14B and 14D. Bars are the mean (n=6)±SEM.

FIG. 16 is a confocal microscopy image illustrating fluorescent antibody labeling against GABA in the right Ae. aegypti AL (lighter); background label (alpha-tubulin) (darker). Scale bar is 20 μm.

FIGS. 17A-17C compare mean ΔF/F time traces for the AM2 glomerulus. GABA receptor antagonists block the suppressive effect of nonanal to AM2's response to the lilac aldehyde in the P. obtusata mixture (17B), causing a significantly higher response than the pre-application (17A) and wash periods (17C) (Kruskal-Wallis test: p<0.05). Traces are the mean (n=4 mosquitoes)±SEM.

FIG. 18 is a table identifying composition and emission rates of the Platanthera orchid scents. The values for the volatile compounds in the scent of each orchid species are presented as percentages. Emission rates are the mean±SD.

FIG. 19 compares Ae. aegypti AM2 responses to lilac aldehyde and DEET at different concentrations: ΔF/F time traces for the AM2 glomerulus stimulated at different concentrations of DEET (left), lilac aldehyde (middle), and the mineral oil control. Lines are the mean; shaded areas are the SEM (n=4-10 mosquitoes).

FIG. 20 compares Ae. aegypti AM2 responses to lilac aldehyde and DEET at different concentrations: dose-response curves for AM2 responses to DEET and lilac aldehyde. Both odorants elicited significant increases in response with increasing dose (R²≥0.75; p<0.05) and were not significantly different in their model fits (p=0.06) (lilac aldehyde: y=1.01x^{0.39}; DEET: y=0.77x^{0.33}).

FIGS. 21A-21D compare behavioral response to mixtures containing different ratios of lilac aldehyde and nonanal: percentage of odorant concentrations in the different mixtures, nonanal and other bioactive constituents were scaled to the same concentrations and ratios as in the total scent of P. obtusata, however the lilac aldehyde concentrations were scaled to the same percentage as in the scent of the other Platanthera orchids, which have 6- to 40-fold higher lilac aldehyde concentrations than P. obtusata (21A); behavioral preferences by Ae. aegypti mosquitoes to scent mixtures containing lilac aldehyde at the concentrations quantified in the different Plathanthera species (21B); same as in 21A, except that lilac aldehyde and other bioactive constituents were maintained at the same concentrations and ratios as in P. obtusata, whereas the nonanal ratios were scaled to the levels of the other Platanthera species (21C); and same as in 21B, behavioral preferences to the scent mixtures with different nonanal ratios (21D). Asterisks denote a significant difference from the mineral oil control (binomial test: p<0.05); number symbol denotes a significant difference from the P. obtusata scent (binomial test:p<0.05).

### DETAILED DESCRIPTION OF THE INVENTION

In one aspect, the present invention provides mosquito attractant compositions and methods for their use as a lure for attracting mosquitos. In other aspects, mosquito repellent compositions and methods for their use to repel mosquitos are provided.

In one aspect of the invention, compositions are provided that include nonanal and lilac aldehydes. As used herein, the term “lilac aldehydes” refers to 5-dimethyl-5-ethenyl-2-tetrahydrofuranacetaldehydes. Lilac aldehydes are a mixture of aldehyde isomers: lilac aldehyde B, lilac aldehyde C, and lilac aldehyde D. The IUPAC name for lilac aldehyde B is (αS,2′S,5′S)-2-(5-ethenyl-5-methyloxolan-2-yl)propanal. The IUPAC name for lilac aldehyde C is (βR,2′R,5′S)-2-(5-ethenyl-5-methyloxolan-2-yl)propanal. The IUPAC name for lilac aldehyde D is (βS,2′R,5′S)-2-(5-ethenyl-5-methyloxolan-2-yl)propanal.

The lilac aldehydes useful in the compositions and methods of the invention are a synthetic mixture of 5-dimethyl-5-ethenyl-2-tetrahydrofuranacetaldehydes: lilac aldehyde B, lilac aldehyde C, and lilac aldehyde D. In one embodiment, the lilac aldehydes (B,C,D isomer mixture) is prepared by oxidation of linalool as described herein. In certain embodiments, the lilac aldehydes include lilac aldehyde B (about 30-70%), lilac aldehyde D (about 15-40%), and lilac aldehyde C (about 15-40%) based on the total weight of lilac aldehydes. In other embodiments, the lilac aldehydes include lilac aldehyde B (about 49%), lilac aldehyde D (about 26%), and lilac aldehyde C (about 23%) based on the total weight of lilac aldehydes.

In one embodiment, the composition includes nonanal and lilac aldehydes, wherein the ratio of nonanal to lilac aldehydes is from about 1:1 to about 100:1 by weight based on the total weight of nonanal and lilac aldehydes.

The compositions of the invention can be incorporated into matrices (e.g., non-volatile liquids and solid substrates) and dispensed from those matrices.

In another embodiment, the composition includes nonanal, lilac aldehydes, and a solvent carrier. The solvent carrier is effective for releasing nonanal and lilac aldehydes at a rate sufficient for the composition to be an effective mosquito attractant or repellent. Suitable solvent carriers include non-volatile solvents. Representative non-volatile solvents include mineral oil, paraffin oil, dipropylene glycol, plant-based oils (e.g., coconut oil), as well as mixtures thereof.

In a further embodiment, the composition includes nonanal, lilac aldehydes, and a substrate. The substrate is effective for releasing nonanal and lilac aldehydes at a rate sufficient for the composition to be an effective mosquito attractant or repellent. Suitable matrices include paraffin wax and paraffin wax emulsion matrices. Other suitable matrices include those commercially available from ISCA Technologies, Inc. (Riverside, Calif.), which are base matrix formulations that include biologically inert materials. Other suitable substrates include wax biopolymers. In such an embodiment, the composition can be mixed with a wax biopolymer for controlled release (Atterholt C., Delwiche M., Rice R., Krochta J., Study of biopolymers and paraffin as potential controlled-release carriers for insect pheromones. Journal of Agricultural and Food Chemistry. 1998; 46(10):4429-4434) and further combined with a toxic-baited sugar trap (1% boric acid with 10% sugar solution in water).

The compositions of the invention can also be effectively dispensed by a variety of methods, including methods known for dispensing pheromones and other attractants and repellents known in the art. Dispensing technologies include polyethylene tube dispensers such as Isomate-CM, and rope dispensers such as Isomate-M100 (Pacific Biocontrol Corporation, Vancouver, Wash.).

In certain embodiments, the compositions noted above further include one or more of heptanal, octanal, 1-octanol, α-pinene, camphene, β-pinene, β-myrcene, D-limonene, eucalyptol, linalool, myrtenol, and benzaldehyde.

In one embodiment, the composition includes nonanal, lilac aldehydes, and octanal.

In another embodiment, the composition includes nonanal, lilac aldehydes, and octanal, 1-octanol, and (R,S)-linalool.

In a further embodiment, the composition includes nonanal, lilac aldehydes, octanal, 1-octanol, and (R,S)-linalool.

In yet another embodiment, the composition includes nonanal, lilac aldehydes, octanal, 1-octanol, (R,S)-linalool, myrtenol, benzaldehyde, α-pinene, camphene, and eucalyptol.

In yet a further embodiment, the composition includes nonanal, lilac aldehydes, heptanal, octanal, 1-octanol, α-pinene, camphene, β-pinene, β-myrcene, D-limonene, eucalyptol, (R,S)-linalool, myrtenol, and benzaldehyde.

In certain embodiments, the compositions of the invention are mosquito attractant formulations. As used herein, the term “attractant formulation” refers to a composition comprising nonanal and lilac aldehydes present in the composition in relative amounts effective to attract mosquitoes.

In certain embodiments, the composition is an attractant formulation. In certain of these embodiments, the ratio of nonanal to lilac aldehydes is about 100:1 based on the amount (mass) of nonanal and lilac aldehydes in the composition. In other embodiments, the ratio of nonanal to lilac aldehydes is about 75:1, about 50:1, about 25:1, about 10:1, or about 5:1 based on the amount (mass) of nonanal and lilac aldehydes in the composition. In one of these embodiments, the ratio of nonanal to lilac aldehydes is about 1:1 based on the amount (mass) of nonanal and lilac aldehydes in the composition.

In certain embodiments, the total solute concentration in the attractant formulation is about 2.6×10⁻⁵ to about 2.6×10⁻⁴ g/mL. Of that mixture, nonanal is present in an amount from about 1×10⁻⁵ to about 1×10⁻⁴ g/mL and lilac aldehydes (B,C,D isomers) are present in an amount from about 1.7×10⁻⁶ to about 1.7×10⁻⁵ g/mL.

In certain embodiments, the attractant formulation further includes octanal. In certain of these embodiments, the attractant formulation includes from about 4×10⁻⁷ to about 4×10⁻⁴ g/mL octanal, as well as nonanal and lilac aldehydes (B,C,D isomers) in the amounts noted above.

In other embodiments, the attractant formulation further includes octanal, 1-octanol, and (R,S)-linalool. In certain of these embodiments, the attractant formulation includes from about 1.8×10⁻⁸ to about 1.8×10⁻⁷ g/mL 1-octanol and from about 2.5×10⁻⁶ to about 2.5×10⁻⁵ g/mL (R,S)-linalool, as well as nonanal, lilac aldehydes (B,C,D isomers), and octanal in the amounts noted above.

In further embodiments, the attractant formulation further includes octanal, 1-octanol, (R,S)-linalool, myrtenol, benzaldehyde, α-pinene, camphene, and eucalyptol. In certain of these embodiments, the attractant formulation includes from about 4×10⁻⁶ to about 4×10⁻⁵ g/mL myrtenol, from about 1×10⁻⁶ to about 1×10⁻⁷ g/mL benzaldehyde, from about 1.6×10⁻⁷ to about 1.6×10⁻⁶ g/mL α-pinene, from about 1×10⁻⁹ to about 1×10⁻⁸ g/mL camphene, and from about 1.6×10⁻⁷ to about 1.6×10⁻⁶ g/mL eucalyptol, as well as nonanal, lilac aldehydes (B,C,D isomers), octanal, 1-octanol, and (R,S)-linalool in the amounts noted above.

The concentrations of components in the compositions of the invention described herein are specified in weight/volume (e.g., g/mL) of the formulation. The weight refers to the component and the volume refers to remainder of the formulation. When the formulation includes a solvent carrier or a substrate, the volume includes the solvent carrier or substrate, respectively.

Advantageously, the attractant formulations of the invention selectively attract mosquitoes and are not attractants for bees or moths. This selectively allows for pairing of the attractant formulations with an insecticide to provide for selective targeting of mosquitoes and not agriculturally-beneficial insects like bees.

In other embodiments, the compositions of the invention are mosquito repellent formulations. As used herein, the term “repellent formulation” refers to a composition comprising nonanal and lilac aldehydes present in the composition in relative amounts effective to repel mosquitoes. The repellent formulations include lilac aldehydes (B,C,D isomers) in an amount greater than about 1×10⁻⁴ g/mL formulation. The attractant formulations described herein can be converted to repellent formulations by increasing the concentration of lilac aldehydes (B,C,D isomers) in the formulation to greater than about 1×10⁻⁴ g/mL. In certain of these embodiments, the ratio of lilac aldehydes to nonanal is about 20:1, about 10:1, about 5:1, or about 2:1 based on the amount (mass) of lilac aldehydes and nonanal in the composition. In one embodiment, the ratio of lilac aldehydes to nonanal is about 6:1 based on the amount (mass) of nonanal and lilac aldehydes in the composition.

In another aspect, the invention provides the use of the compositions (i.e., attractant formulations) as a mosquito attractant. Mosquitoes that are attracted to the attractant formulations of the invention include mosquitoes that feed on sugar and nectar.

Specific mosquito species that are effectively attracted to the formulations include male and female mosquitoes of the species Aedes aegypti, Anopheles stephensi, Culex quinquefasciatus, Aedess communis, Aedes increpitus, and Aedes canadensis.

Relatedly, the invention provides methods for attracting a mosquito to a pre-determined location, comprising positioning a composition of the invention (i.e., attractant formulation) at the pre-determined location. In certain embodiments, the pre-determined location is a mosquito breeding area, such as standing water and bushes.

In a further aspect, the invention provides the use of the compositions (i.e., repellent formulations) as a mosquito repellent. Mosquitoes that are repelled by the repellent formulations of the invention include mosquitoes that feed on sugar and nectar.

Specific mosquito species that are effectively attracted to the formulations include male and female mosquitoes of the species Aedes aegypti, Anopheles stephensi, Culex quinquefasciatus, Aedess communis, Aedes increpitus, and Aedes canadensis.

Relatedly, the invention provides methods for repelling a mosquito from a pre-determined location, comprising positioning a composition of the invention (i.e., repellent formulation) at the pre-determined location. In certain embodiments, the pre-determined location is a mosquito breeding area, such as standing water and bushes.

The following describes representative compositions and methods for their use for attracting mosquitoes.

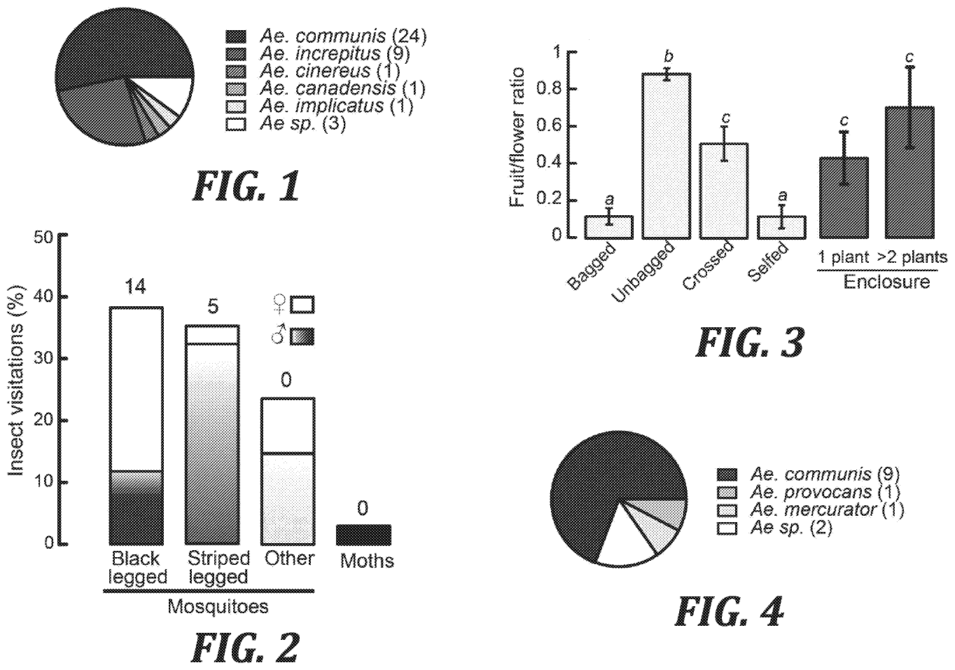

To understand the importance of various pollinators, including mosquitoes, on P. obtusata, pollinator observation and exclusion experiments were conducted in northern Washington State where Platanthera orchids and mosquitoes are abundant. Using a combination of video recordings and focal observations by trained participants, more than 581 P. obtusata flowers were observed for a total of 47 h, with 57 floral feeding events by mosquitoes. During these observations, flowers were almost solely visited by various mosquito species (both sexes) that mainly belonged to the Aedes group (FIGS. 1 and 2), with the only other visitor being a single geometrid moth. Mosquitoes quickly located these rather inconspicuous flowers, even on plants that were bagged and thus lacked a visual display. After landing on the flower, the mosquito's probing of the nectar spur resulted in pollinia attachment to its eyes. Most of the pollinia-bearing mosquitoes had one or two pollinia, but up to four pollinia were observed on a single female. To assess the impact of the mosquitoes' visits on the orchid fruit set, a series of pollination experiments were conducted, such as bagging (thus preventing mosquito visitations) and cross- and self-pollinating the plants. Significantly higher fruit-to-flower ratios and seed sets in unbagged plants were found compared with those in bagged or self-pollinated plants (FIG. 3; Mann-Whitney Test, p<0.001), and elevated fruit ratios in our cross-pollinated plants compared with bagged or self-pollinated plants (FIG. 3). In the field, field-caught mosquitoes were released into cages containing either a single plant or 2-3 plants (FIGS. 3 and 4). Once released into the cages, the mosquitoes fed from the P. obtusata flowers, and approximately 10% of the mosquitoes showed pollinia attachment. There was a strong trend for cages with two or more plants to have higher fruit-to-flower ratios than those with one plant (Mann-Whitney Test, p=0.07), although the low sample size for locations with 2-3 plants (rare at these sites; n=8) may explain the lack of significance at α=0.05. Nonetheless, cages containing two or more plants had significantly higher fruit-to-flower ratios than bagged plants (Mann-Whitney Test, p<0.001), but were not statistically different from the unbagged plants (Mann-Whitney Test, p=0.84), further suggesting that cross-pollination is important in this orchid species.

Platanthera Orchids Differ in their Floral Scents

Platanthera obtusata has a short (about 12 cm) inflorescence, and flowers emit a faint grassy- and musky-type of scent. The height and green coloration of the flowers make this plant difficult to pick out from neighboring vegetation, but throughout the observations, it was noticed that mosquitoes readily oriented and flew to the flowers, exhibiting a zig-zagging flight typical of odor-conditioned optomotor anemotaxis. Moreover, even when the plants were bagged (thereby preventing the visual display of the flowers) mosquitoes would still land and attempt to probe the plants through the bag.

In the Platanthera genus, species differ in their floral advertisements, including their scent, and this is reflected in the different pollinators visiting each orchid species. Often these species can co-occur in the same sedge, such as P. obtusata, P. stricta, P. dilatata, and P. huronensis, although hybridization can rare. Mosquitoes have sensitive olfactory systems that are used to locate important nutrient sources, including nectar. Observations on the strength of the association between P. obtusata and the mosquitoes, and how mosquitoes were able to locate the P. obtusata orchids, motivated us to examine the scent of closely related Platanthera species and identify the putative volatiles that mosquitoes might be used to detect and discriminate between the different orchid species.

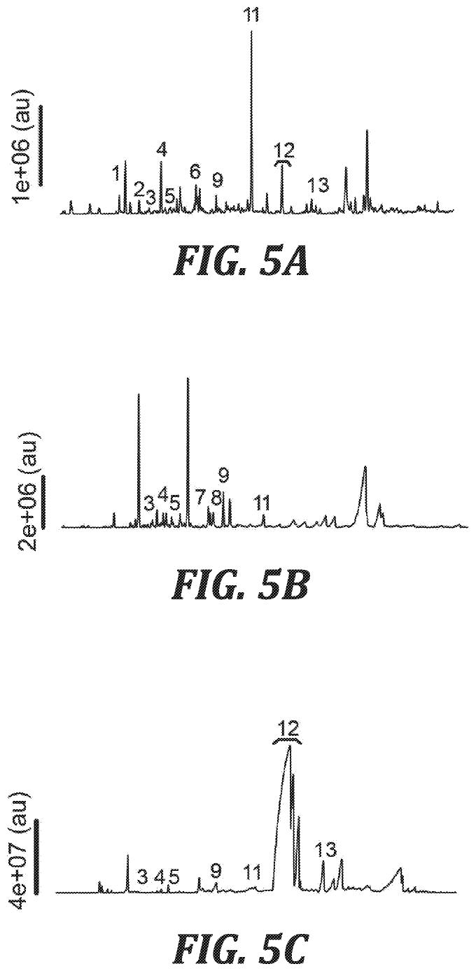

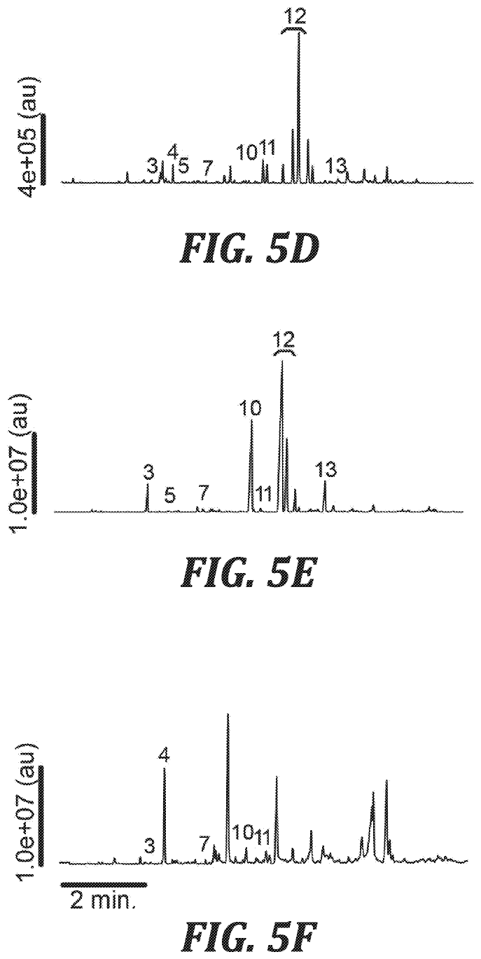

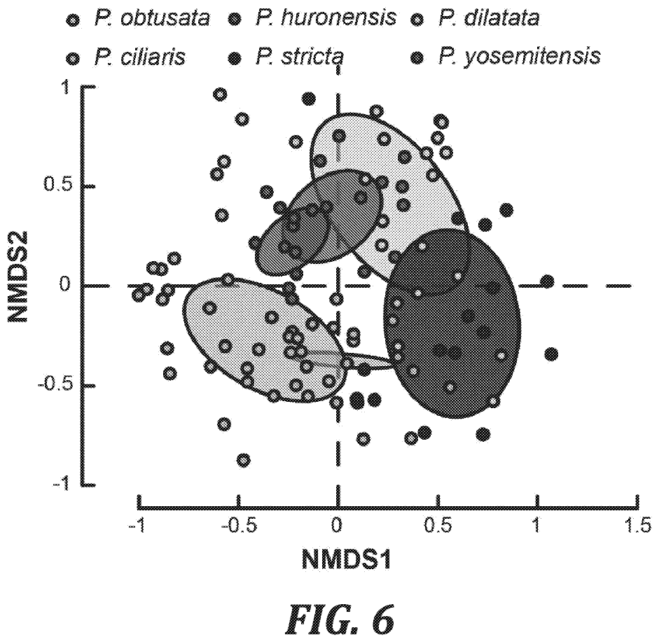

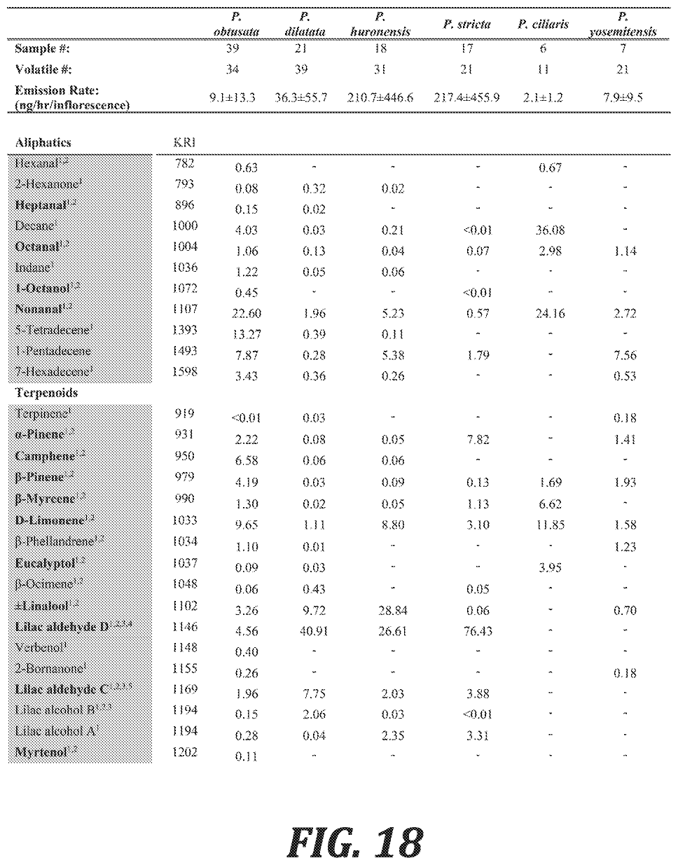

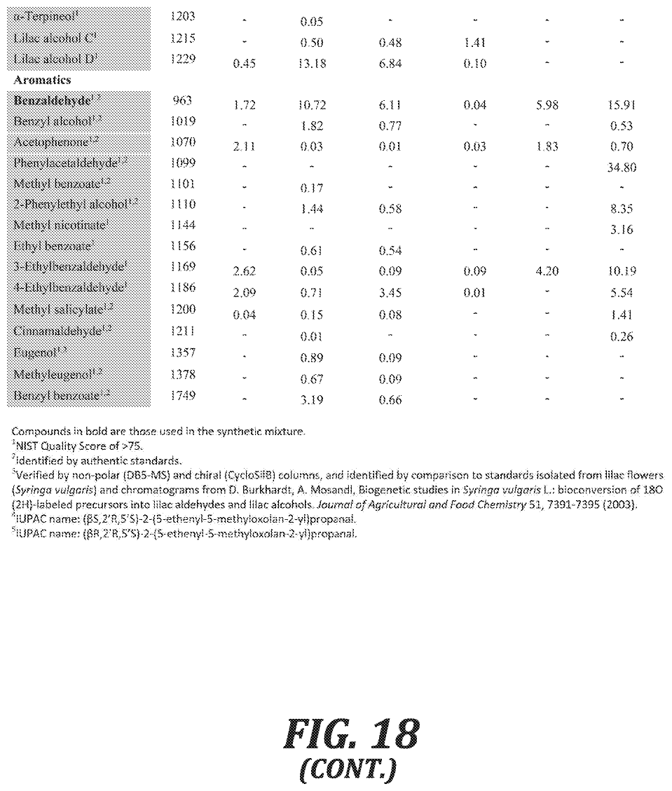

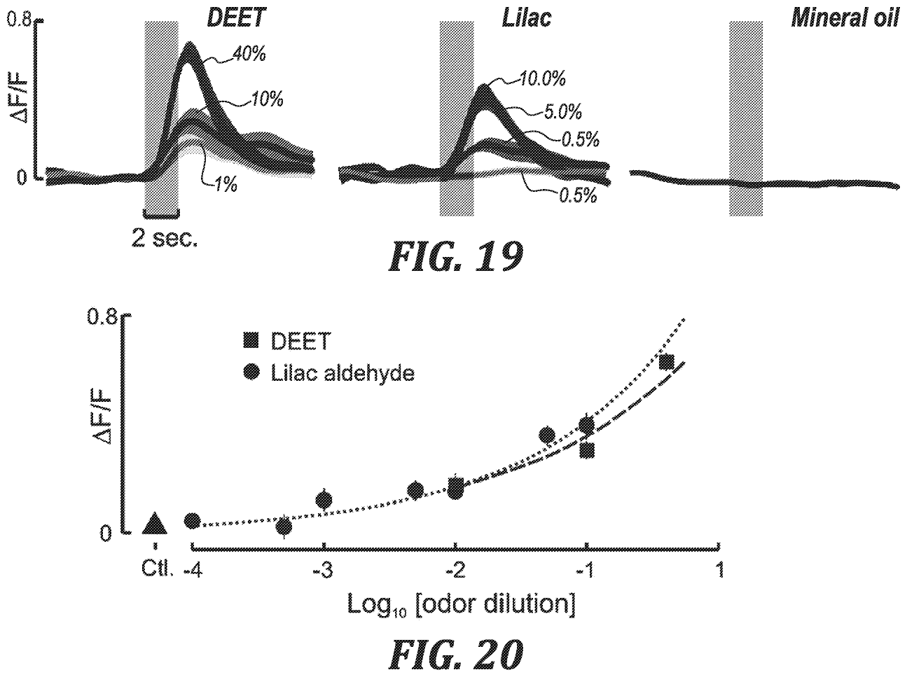

The floral scents of the six orchid species were collected and subsequently characterized using gas chromatography with mass spectrometry (FIGS. 5A-5F). These analyses showed that species differed in both scent emissions and compositions (FIGS. 6 and 18; composition: ANOSIM, R=0.25, p=0.001; emission rate: Student t-tests, p<0.05). Mosquito-pollinated P. obtusata flowers predominantly emitted nonanal and octanal, and low levels of terpene compounds (linalool, lilac aldehyde), whereas the other orchid species, which are pollinated by other insect taxa, emitted scents that were enriched in terpene compounds, such as lilac aldehyde (e.g., P. dilatata, P. huronensis, and P. stricta), or aromatic compounds, such as phenylacetaldehyde (e.g., P. yosemitensis).

Divergent Mosquitoes Show Similar Antennal and Behavioral Responses to the P. obtusata Orchid Scent

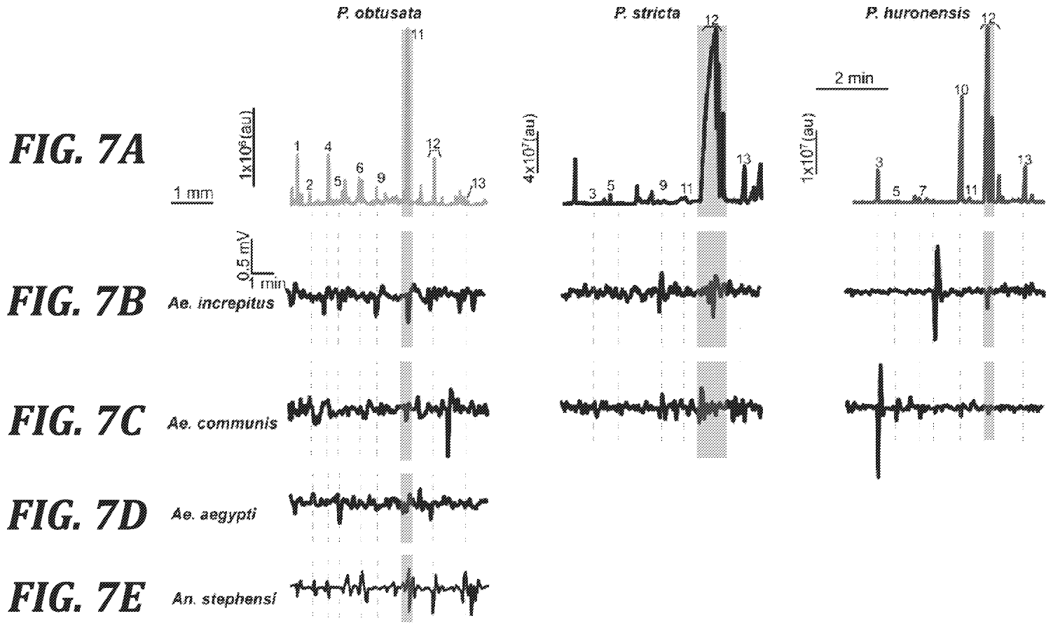

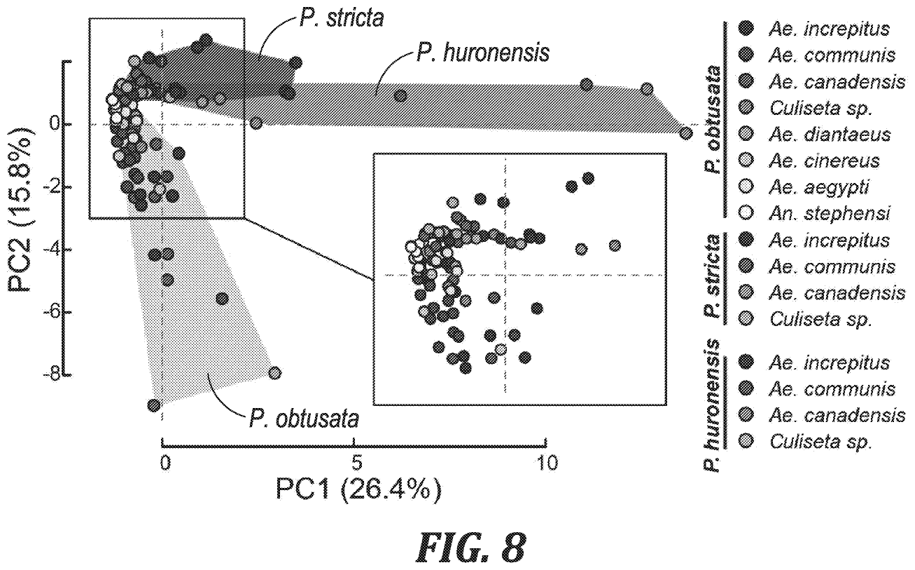

To identify volatile compounds that mosquitoes might use to detect the plants, gas chromatography coupled with electroantennographic detection (GC-EADs) was performed using various species of mosquitoes that visit P. obtusata flowers in the field. Several chemicals evoked antennal responses in the Aedes mosquitoes, including aliphatic (nonanal and octanal) and terpenoid compounds (e.g., lilac aldehydes, camphene and α- and β-pinene) (FIGS. 7A-7E). For example. across the Aedes-Ochlerotatus group, nonanal elicited consistent responses and one of the strongest relative responses within a given mosquito species (FIGS. 7A-7E). Interestingly, Culiseta mosquitoes, which also visited P. obtusata but did not have pollinia attachment, showed very little response to nonanal. Although mosquito species showed differences in their response magnitude to the chemicals (FIGS. 7A-7E), the responses were relatively consistent which was reflected in their overlapping distribution in multivariate (Principal Components Analysis) space (ANOSIM, R=0.076, P=0.166) (FIG. 8). This similarity in evoked responses by Aedes mosquitoes led to the examination of whether these chemicals also evoked similar responses in other mosquitoes. Thus two species of mosquitoes were used that are not native to the area, but are closely (Ae. aegypti) or distantly (Anopheles stephensi) related to the other Aedes species. The non-native mosquitoes (Ae. aegypti and An. stephensi) also responded to these volatiles and were not significantly different in their responses to the other Aedes species (ANOSIM, R=0.087, p=0.09) (FIG. 8).

P. obtusata occurs in sympatry with P. huronensis, P. dilatata, and P. stricta, but we did not observe Aedes mosquitoes visiting these orchids. To examine whether these differences in orchid visitation arise from differences in antennal responses, GC-EADs were performed using the scents of P. stricta and P. huronensis, which are predominantly pollinated by bees, moths, and butterflies. Results showed that the mosquitoes (Ae. increpitus, Ae. communis, Ae. canadensis, and Culiseta sp.), which co-exist with these orchids in the same habitat, all responded to several compounds, including linalool, nonanal, benzaldehyde, β-myrcene and lilac aldehydes (FIGS. 7A-7E). In particular, the high concentration of lilac aldehydes in the scent of P. stricta, and to a lesser extent in P. huronensis, elicited relatively strong responses in the antennae of Ae. increpitus and Ae. communis. Despite occurring in sympatry and overlapping in their scent composition, mosquito antennal responses to the three different orchid scents were significantly different from one another (FIG. 8; ANOSIM, R=0.137, p<0.01), suggesting that the orchid species pollinated by other insects were activating distinct olfactory channels in the mosquitoes.

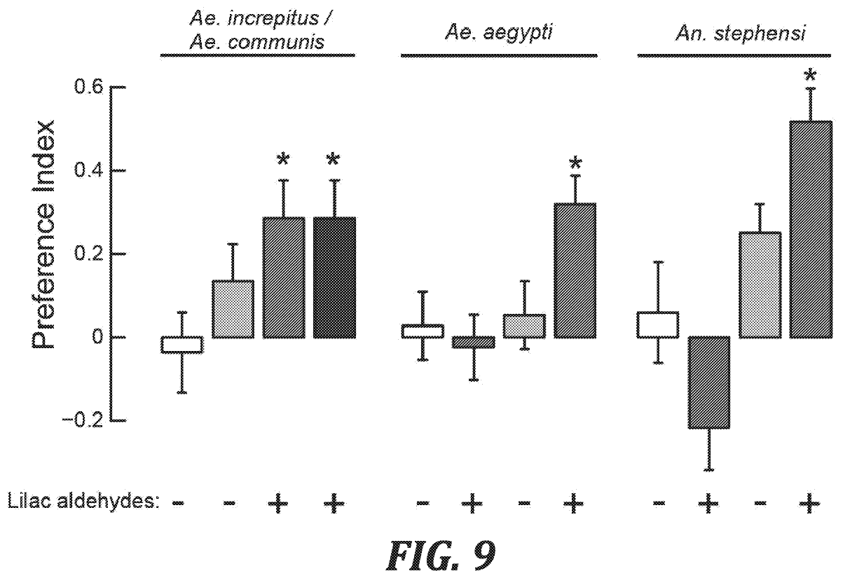

To evaluate if the P. obtusata orchid scent attracts mosquitoes, we tested the behavior of Ae. increpitus and Ae. communis mosquitoes (both important pollinators of P. obtusata) in response to the scent emitted by live P. obtusata flowers, as well as by an artificial mixture composed of the floral volatiles that elicited strong antennal responses in mosquitoes. Both the artificial mixture and the scent from the flowers significantly attracted these mosquitoes (FIG. 9; binomial tests: p<0.05). However, upon removal of lilac aldehyde (about 5.4 ng) from the mixture emissions, the attraction was reduced (binomial test: p=0.292).

The similarity between mosquito species in their antennal responses to volatiles in the P. obtusata scent (FIGS. 7A-7E) raised the question of whether closely related (Ae. aegypti) and more distantly related (An. stephensi) mosquitoes might also be attracted to the orchid scent. When tested in the olfactometer, both Ae. aegypti and An. stephensi mosquitoes exhibited significant attraction to the orchid scent with the lilac aldehydes (binomial tests: p<0.05). By contrast, and similar to responses by Aedes mosquitoes, once the lilac aldehydes were removed from the mixture, this attraction was reduced to levels approaching the mineral oil (no odor) control (FIG. 9). Nonetheless, the attraction by these other mosquito species may not indicate that pollinia also attaches to their eyes, or that they may serve as pollinators. To address this question, both male and female Ae. aegypti mosquitoes were released into cages with flowering P. obtusata plants. Once entering the cage, the mosquitoes immediately fed from the flowers, and pollinia attached to their eyes similar to the other Aedes species.

The P. obtusata Orchid Scent Evokes Strong Responses in the Mosquito Antennal Lobe

The differences in floral scents between the orchid species, and the behavioral responses by different mosquito species to the P. obtusata scent, raised the question of how this chemical information was represented in the mosquito's primary olfactory center, the antennal lobe (AL). Therefore, bath application of a calcium indicator (Fluo4) was used in Ae. increpitus and the PUb-GCaMP6s line of Ae. aegypti mosquitoes (M. Bui et al., Live calcium imaging of Aedes aegypti neuronal tissues reveals differential importance of chemosensory systems for life-history-specific foraging strategies. BMC Neuroscience, 20, 1-17 (2019); C. Vinauger et al., Visual-olfactory integration in the human disease vector mosquito Aedes aegypti. Current Biology 29, 2509-2516. e5 (2019)). Although both calcium indicators do not allow explicit recording of specific cell types in the AL, they do provide an ability to record and characterize the responses of individual glomeruli to odor stimuli. Mosquitoes were glued to holders that permitted two-photon imaging of calcium responses in the AL during tethered flight and tentative registration and naming of glomeruli. For both mosquito species, odor stimulation evoked distinct calcium dynamics in the glomerular regions of the AL that were time-locked to stimulus onset. The orchid mixture evoked flight responses and strong (>20% ΔF/F) multi-glomerular patterns of activity in both mosquito species, particularly in the anterior-medial glomeruli (the putative AM2, AM3, and V1 glomeruli) and the anterior-lateral glomeruli (AL3, and LC2). In addition, certain odorants elicited overlapping patterns of glomerular activity similar to those elicited by the orchid scent, such as nonanal in the AL3 and LC2 glomeruli, with the LC2 glomerulus showing the strongest response to nonanal, octanal, and 1-octanol. Although the anterior-medial glomeruli showed broader tuning in Ae. increpitus than in Ae. aegypti, these glomeruli were sensitive to terpene compounds in both species and the AM2 glomerulus often exhibited inhibition when stimulated with nonanal. Interestingly, for Ae. aegypti, the AM2 glomerulus showed the strongest response to lilac aldehyde, followed by DEET, a strong mosquito repellent, although these responses were suppressed when stimulated with the orchid mixture. However, other odor stimuli, including human scent, evoked a dissimilar pattern of glomerular activity compared with the orchid mixture.

Inhibition in the Mosquito AL Plays an Important Role in the Processing of the Orchid Scents

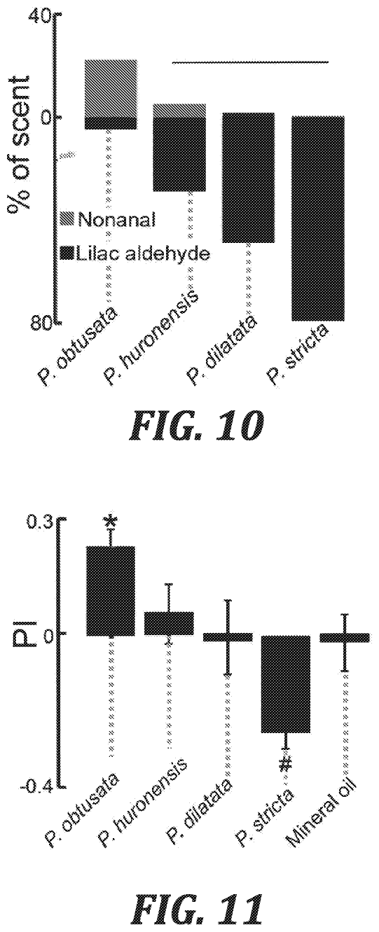

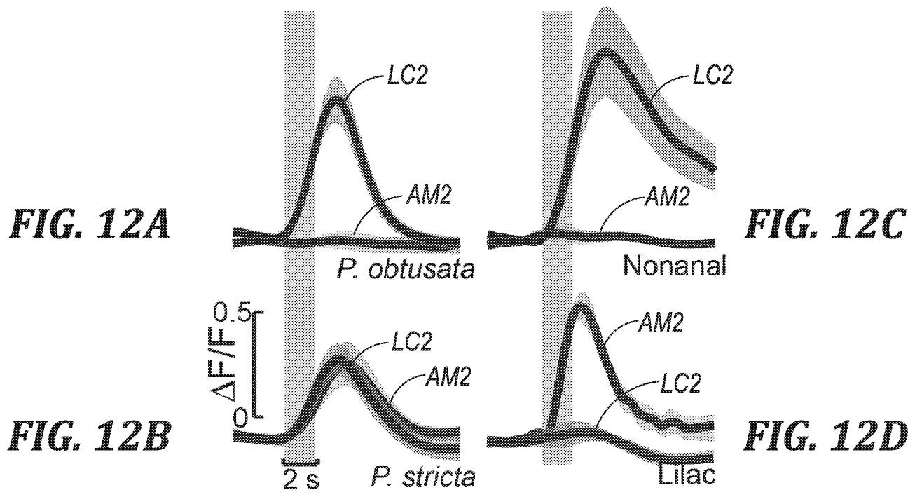

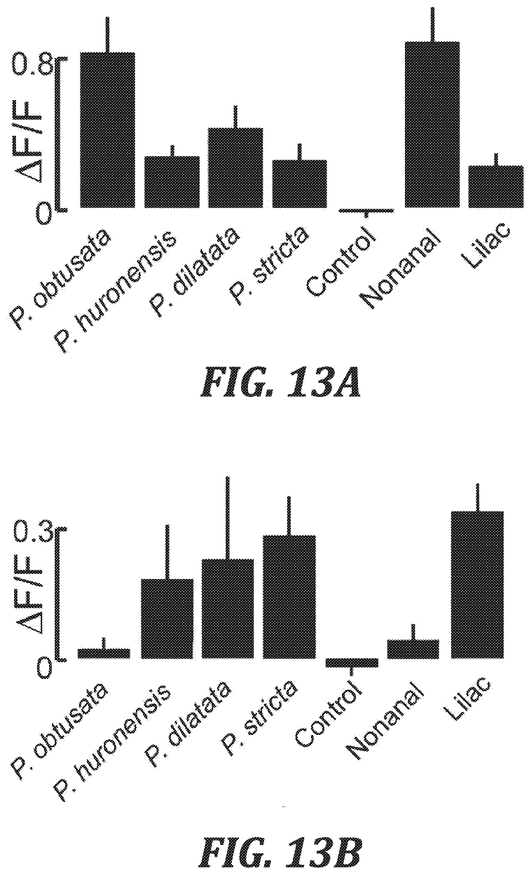

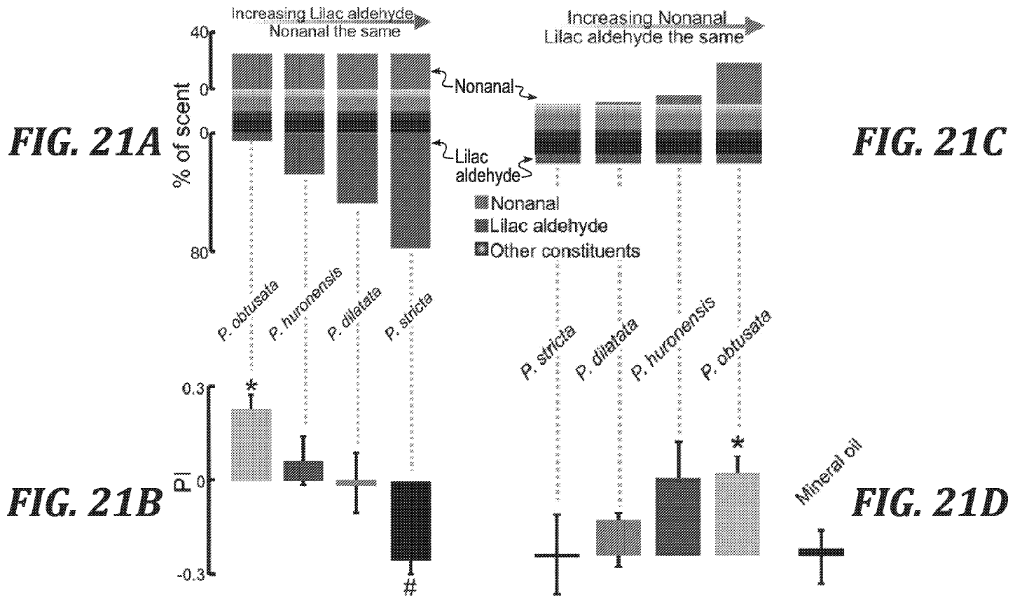

Results from calcium imaging and behavioral experiments suggested that certain volatile compounds, such as nonanal and lilac aldehyde, are particularly important for mosquito responses to P. obtusata. However, the other Platanthera species that are primarily pollinated by different insects (but avoided by Aedes mosquitoes), also emit these volatile compounds, but at different ratios (FIG. 10). To examine how mosquitoes respond to the scents of the other Platanthera species and to determine the importance of odorant ratios for the behavioral preferences, the ratio of lilac aldehyde was increased in the artificial P. obtusata mixture to the levels found in the different Platanthera species. However, in these mixtures the other odor constituents (including nonanal) were kept at the same levels as in P. obtusata, thus allowing the examination of how changing the concentration of one component (lilac aldehyde) altered the behavior (FIGS. 10 and 21A). Data showed that the increase in lilac aldehyde elicited behavioral responses that were not significantly different from the solvent control (binomial tests: p>0.05) or elicited an aversive response when compared with the P. obtusata mixture (FIG. 11; binomial tests: p<0.05). Similarly, when the nonanal ratio was decreased in the mixture to the levels of the other Platanthera species, the behavioral efficacy of these mixtures decreased to levels that were not significantly different from the solvent control (FIGS. 21C and 21D); binomial tests: p>0.05). To examine the relationship between mosquito behavior and AL response, glomerular responses were compared to the odors of the different orchid species. Stimulation with the P. obtusata mixture evoked strong glomerular responses in the AL, particularly in the AL3 and LC2 glomeruli, whereas stimulation with the other Platanthera scents (containing much higher lilac aldehyde: nonanal ratios) showed decreased responses in the LC2 glomerulus; however, the AM2 glomerulus (responsive to lilac aldehyde and DEET) showed much stronger responses (FIGS. 12A, 12B, 13A, and 13B; Kruskal-Wallis test with multiple comparisons: p<0.05).

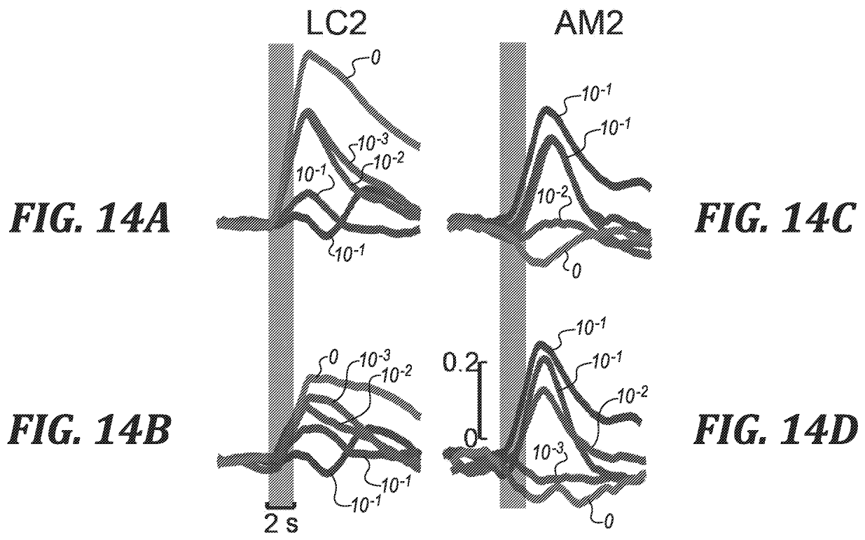

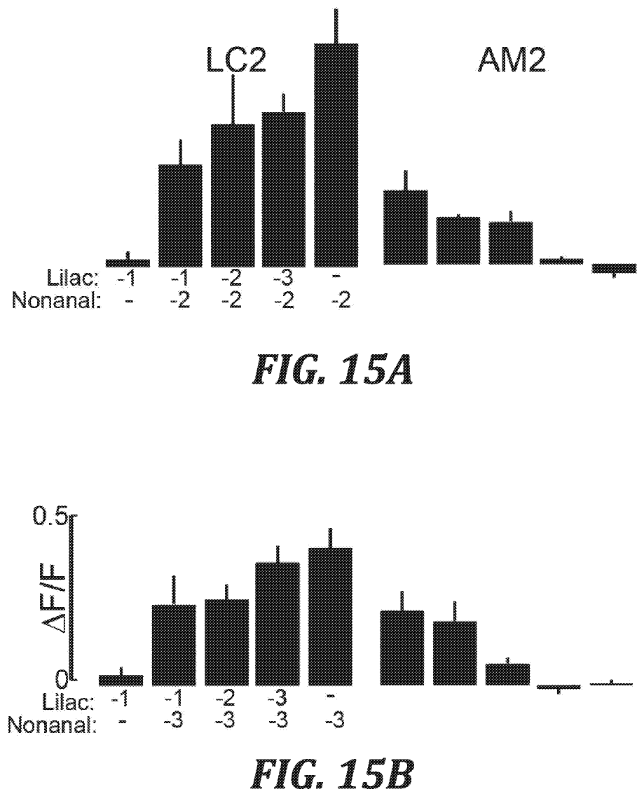

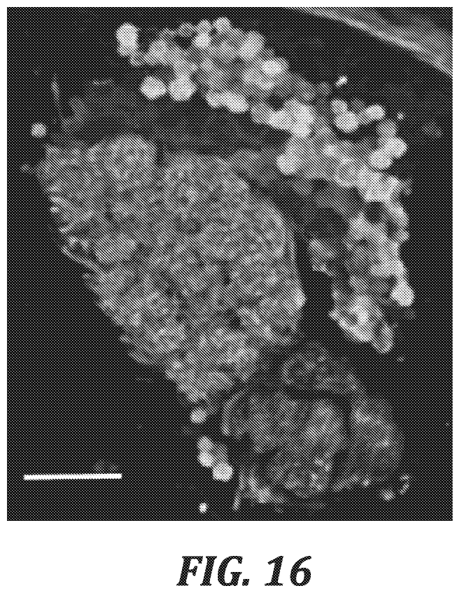

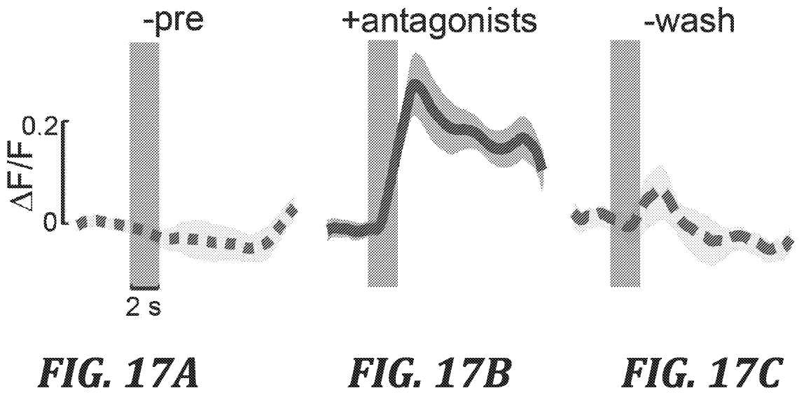

To better understand how the ratio of lilac aldehyde and nonanal altered the activation of the LC2 and AM2 glomeruli, mixtures of lilac aldehyde and nonanal were tested at different concentration ratios and found that lilac aldehyde suppressed the response of LC2 to nonanal, suggesting lateral inhibition between these two glomeruli. Higher lilac aldehyde concentrations increased LC2 suppression, but reciprocally increased AM2 activation (FIGS. 14A-14D, 15A, and 15B). By contrast, nonanal caused suppression of AM2 responses to lilac aldehyde, with higher nonanal concentrations causing increased AM2 suppression, while increasing the activation of LC2 (FIGS. 14A-14D, 15A, and 15B). To determine whether this suppression of glomerular activity is mediated by γ-aminobutyric acid (GABA), an important inhibitory neurotransmitter in insect olfactory systems, antisera against GABA was used in the Ae. aegypti brain and found widespread labeling in AL glomeruli, including AM2 and LC2 (FIG. 16). Next, the inhibition was pharmacologically manipulated by focally applying GABA-receptor antagonists (1 μM CGP54626; 10 μM picrotoxin) on to the AL during our experiments. During application of the vehicle (saline) control, LC2 and AM2 responses to the P. obtusata scent were similar to those described above (FIGS. 14A-14D, 15A, 15B, 17A-17C), whereas during antagonist application, the effect of nonanal was blocked and the small amount of lilac aldehyde in the scent was sufficient to evoke a strong response in AM2 (FIGS. 17A-17C). The antagonists blocked the symmetrical inhibition by nonanal and lilac aldehyde in the P. stricta scent, causing increased response in both glomeruli, with the LC2 response levels similar to those evoked by P. obtusata. Together, these results support the hypothesis that the ratios of volatile compounds in the orchid scents, and the resulting balance of excitation and inhibition in the mosquito AL, play an important role in mediating mosquito attraction to

P. obtusata and possibly, reproductive isolation between orchid species. As described herein, a unique mutualism between P. obtusata orchids and Aedes mosquitoes was used to show the importance of mosquito pollination for this orchid and the role of scent in mediating this association. Olfactory cues play important roles in a variety of biological processes for mosquitoes, including locating suitable hosts, oviposition sites, and nectar sources. For Aedes mosquitoes to efficiently locate sources of nutrients, they must distinguish between complex floral scents in a dynamic chemical environment. In the case of sympatric Platanthera orchids—which share the same scent constituents but differ in their ratios of nonanal and lilac aldehydes—their scents evoke distinct patterns of activation in AL glomeruli. The results suggest that GABA-mediated lateral inhibition from the LC2 glomerulus that encodes nonanal (found in higher abundance in P. obtusata) suppresses responses of glomeruli encoding lilac aldehydes (abundant in the scent of the other Platanthera species) which allows mosquitoes to distinguish between orchids.

There are only a handful of mosquito-pollinated flowers, but some of these species have been shown to emit similar volatile profiles as P. obtusata. The results showed that certain terpene volatiles, like lilac aldehyde, were important in the discrimination of the P. obtusata scent, and at low concentrations, this volatile was important for attracting diverse mosquito species. In other mosquitoes, oxygenated terpene compounds that are derivatives of linalool, like lilac aldehyde and linalool oxide, were shown to elicit attraction to nectar sources. The qualitative similarities in the scent profiles of attractive nectar sources, and the attractiveness of the P. obtusata scent across mosquito species, raises the question of whether flower scents may be activating conserved olfactory channels, such as homologous odorant receptors.

The results described herein also demonstrate the importance of mixtures and the processing of odorant ratios in Aedes. Interestingly, some of the volatile compounds emitted from blood hosts also occur in the P. obtusata scent, including nonanal. However, in both Ae. increpitus and Ae. aegypti mosquitoes, the AL representations of host and orchid scents were different, suggesting that these odors may be processed via distinct olfactory channels. Despite the different glomerular ensemble responses, the complex nectar and host odors may share some of the same coding processes by AL circuits, including lateral inhibition of glomeruli. Similar to floral scents, human odors are complex mixtures that can differ between individuals in their constituent ratios, which may explain why mosquitoes often show behavioral preferences for certain individuals over others. These dissimilarities have important epidemiological implications for disease transmission and could be related to the subtle differences in the ratios of key compounds in an individual's scent.

In certain embodiments, the compositions of the invention are defined as “comprising” the specified component (i.e., include the specified component as well as other unspecified components). It will be appreciated that in addition to the compositions that “comprise” the specified components, the compositions of the invention also include compositions that “consist of” the specified components (i.e., only include the specified components and no others).

As used herein, the term “about” refers to ±5% of the specified value.

Materials and Methods

Procedures for floral volatile organic compound (VOC) collection and analysis, mosquito rearing, the preparation used for GC-EAD experiments, behavior experiments and associated stimuli, olfactory stimuli and pharmacological reagents used in calcium imaging experiments, and immunohistochemistry are described below.

Orchid-Pollinator Observations and Pollination Experiments

Flower observations. Pollinator activity was monitored in the Okanogan-Wenatchee National Forest (47.847° N, 120.707° W; WA, USA) from late June to early July in 2016 and 2017 when the flowers of P. obtusata were in full bloom. Multiple direct and video observations of varying lengths from 30 minutes to 2.5 h were made for a total of 46.7 hours (15 hours of direct and 31.7 hours of video recordings). The observations were conducted from 10 am to 8 pm when mosquitoes were found to visit the flowers. Observations were recorded by visually inspecting each plant, with the trained observer approximately 1 m away from the plant—this distance did not influence the feeding and mosquito-flower visitation since no mosquito took off from the plant in the field and instead remained busy feeding from flower after flower. To further prevent the potential for observer interference, video observations were made using GoPro® Hero4 Silver (San Mateo, Calif. USA) fitted with a 128 gb Lexar® High-Performance 633× microSD card. Videos were set at 720p resolution, 30 frames per second, and “Narrow” field of view. These settings were optimized for the memory capacity, battery life, and best resolution by the camera. Both observation methods, direct and video, provided similar visitation rates. The visitation time, insect identity, leg color, and sex (for mosquitoes), were recorded from both direct and video observations. The number of feeding (defined by the probing into the flower using the proboscis) and visits (non-feeding or resting) were quantified per hour per flower for each pollinator type. Over the course of the experiments and observations, temperatures ranged from 9.6° to 32.3° C., with a relative humidity range of 13.4% to 100% (iButtons; Maxim Integrated™ San Jose, Calif., USA, #D51923). These experiments, therefore, captured both sunny and rainy weather conditions that were common in this area at this time of the year.

Pollinator Addition Experiments.

To evaluate the contribution of mosquitoes to the pollination of P. obtusata orchids, pollinator addition experiments were performed during June through July in 2016. Mosquitoes were collected from the Okanogan-Wenatchee National Forest using CDC Wilton traps baited with carbon dioxide (John W. Hock Company, Gainesville, Fla., USA). Carbon dioxide traps provide a standardized method to sample the mosquito assemblages near and among wetland habitats. Traps were placed within the sedge habitat, but more than 60 m from the nearest focal flower patch to prevent any disturbance.

P. obtusata from the same site was enclosed in Bug Dorm cages (30 cm×30 cm×30 cm; BioQuip® Products, Rancho Dominguez, Calif., USA, #1452) for which the bottom panel was removed to cover the orchid. Thirty mosquitoes were introduced into each cage through a sleeve located on the front panel and left without human interference for a duration of 48 h, after which the mosquitoes were collected from the enclosures and identified. The number and species of mosquitoes with pollinium attached were recorded, and plant was bagged for determination of the fruit-to-flower ratio at the end of the field season. A total of nineteen enclosures were used; 11 enclosures with a single plant, and 8 enclosures with 2-3 plants.

Pollen Limitation Studies.

To determine the importance of pollination and out-crossing on P. obtusata fruit set, plants were subject to four different experimental treatments during the June through July summer months. For two weeks, plants were either unbagged (n=20 plants) or bagged to prevent pollinator visitation (n=19 plants). Organza bags (Model B07735-1; Housweety, Causeway Bay, Hong-Kong) were used to prevent pollinators from visiting the flowers. In addition, the importance of cross- and self-pollination for P. obtusata was determined. For cross pollination, six pollinia were removed from two plants using a toothpick and gently brushed against the stigma of a neighboring plant (n=11 plants). To examine the effects of self-pollination, six pollinia were removed from three flowers and gently brushed the flowers on the same plant (n=9 plants). At the end of the field season, the number of flowers and the number of fruits produced per individual plants were recorded and the fruit-to-flower ratios were calculated. For comparing the fruit weights and the seed set for each treatment, up to four fruits from each individual of P. obtusata were collected. The weights were measured with a digital scale (Mettler Toledo, Columbus, Ohio, USA), and the number of viable seeds per fruit were counted using an epifluorescent microscope (60× magnification; Nikon Ti4000). Fruit weights and seed sets were compared using a Student's t-test; fruit-flower ratios were compared using a Mann-Whitney Test.

Floral VOCs Collection and Analysis

Orchid Species.

To characterize the orchid scents, headspace collections were performed during the summers of 2014, 2015 and 2016 in the Okanogan-Wenatchee National Forest (Washington, USA) and Yosemite National Park (California, USA). The scents of six Platanthera orchid species were studied: P. obtusata ((Banks ex Pursh) Lindley), the blunt-leaved orchid; P. stricta (Lindley), the slender bog orchid; P. huronensis (Lindley), the green bog orchid; P. dilatata (Pursh), the white bog orchid; P. yosemitensis (Colwell, Sheviak and Moore), the Yosemite bog orchid and P. ciliaris (Lindley), the yellow fringed orchid. In the field, the plants were identified using a key. P. ciliaris was obtained from a nursery (Great Lakes Orchid LLC, Belleville, Mich., USA) and maintained in the greenhouse of the Biology Department, at the University of Washington in Seattle, USA. Specimens of P. obtusata, P. stricta, and P. dilatata were also maintained in the greenhouse as well as sampled in the field. For all orchid species, scents were collected during their peak flowering time and from those with unpollinated flowers.

Floral Scent Collection.

To collect the flower scent, the inflorescence of the plant was enclosed in a nylon oven bag (Reynolds Kitchens, USA) that was tight around the stem. Two Tygon tubes (Cole-Parmer, USA) were inserted at the base of the bag; one providing air into the bag through a charcoal filter cartridge (1 L/min.) to remove any contaminants from the pump or the surrounding air, and the other tube pulling the air out of the bag (1 L/min.) through a headspace trap composed of a borosilicate Pasteur pipette (VWR, Radnor, Pa., USA) containing 50 mg of Porapak powder Q 80-100 mesh (Waters Corporation, Milford, Mass., USA). This amount of Porapak was calibrated for collecting the orchid headspace without bleed through. The tubes were connected to a diaphragm pump (Diaphragm pump 400-1901, Barnant Co., Barrington, Ill., USA for the greenhouse VOCs collection; Diaphragm pump 10D1125-101-1052, Gast, Benton Harbor, Mich., USA, for the field VOCs collection connected to a Power-Sonic PS-6200 Battery, M&B's Battery Company). Immediately after headspace collection, traps were eluted with 600 μL of 99% purity hexane (Sigma Aldrich, Saint-Louis, Mo., USA). The samples were sealed and stored in 2 mL amber borosilicate vials (VWR, Radnor, Pa.) with Teflon-lined caps (VWR, Radnor, Pa.) on ice until reaching the laboratory, where they were stored at −80° C. until analysis by GCMS. Because some orchid species are pollinated by nocturnal moths (e.g., P. dilatata), whereas others are pollinated by diurnal insects (e.g., P. obtusata), collections were normalized across Platanthera species for an entire 24 h period, excepting those of P. ciliaris which was collected for 72 h to account for the chemical analyses and relative abundance in the scent. For headspace controls, samples were taken concurrently from empty oven bags and from the leaves of the plants (as vegetation-only controls). Seven to thirty-nine (7-39) floral headspace collections were conducted for each orchid species for a total of 109 floral headspace samples.

Gas Chromatography with Mass Spectrometric Detection of the Orchid Scents.

One to three microliters of each sample were injected into an Agilent 7890A GC and 5975C Network Mass Selective Detector (Agilent Technologies, Palo Alto, Calif., USA). A DB-5 GC column (J&W Scientific, Folsom, Calif., USA; 30 m, 0.25 mm, 0.25 pm) was used, and helium was used as the carrier gas at a constant flow of 1 cc/min. For runs with the DB-5 column, the oven temperature was 45° C. for 4 min, followed by a heating gradient of 10° to 230° C., which was then held isothermally for 6 min. The total run time was 28.5 min. A Cyclosil-B column (J&W Scientific, Folsom, Calif., USA; 30 m, 0.25 mm, 0.25 pm) was used to examine the stereoisomer composition of the lilac aldehyde in the floral scents. For the chiral column, the oven temperature was 45° C. for 6 min, followed by a heating gradient of 5° to 160° C., then 15° to 200° C. which was then held isothermally for 5 min. The total run time was 36.7 min. Natural lilac aldehydes were isolated from lilac flowers (Syringa vulgaris) to create a natural standard because lilac flowers are known to contain 4 out of 8 possible lilac aldehyde stereoisomers, all of which have the 5′S configuration. The natural standard was prepared by purifying the lilac aldehydes from Syringa vulgaris flowers by CO₂ extract (Hermitage Oils, Petrognano, IT) using column chromatography with Silica Gel 60, mesh 230-400 (Material Harvest Ltd, Cambridge, UK), and eluted with 90% hexanes, 10% ethyl acetate. 1 μl of the sample was injected into the GCMS with the chiral column. The lilac aldehyde peaks from Platanthera samples were matched with peaks from lilac aldehyde purified from lilac flower CO₂ extract using the ChemStation software (Agilent Technologies, Santa Clara, Calif., USA). The lilac aldehyde peaks in the samples, and in the standard purified from lilac flower CO₂ extract were matched based on their retention indices.

Chromatogram peaks were then manually integrated using the ChemStation software (Agilent Technologies, Santa Clara, Calif., USA) and tentatively identified by the online NIST library. Using methods for identifying and quantifying volatiles in floral headspace emissions (R. T. Cardé, G. Gibson, Host finding by female mosquitoes: mechanisms of orientation to host odours and other cues. Olfaction in vector-host interactions 2010, 115-142 (2010); C. J. McMeniman, R. A. Corfas, B. J. Matthews, S. A. Ritchie, L. B. Vosshall, Multimodal integration of carbon dioxide and other sensory cues drives mosquito attraction to humans. Cell 156, 1060-1071 (2014)) the data from each sample was first run through a custom program (https://github.com/cliffmar/GCMS_and_combine) to identify the volatiles based on their Kovats index and to remove potential contaminants and chemical synonyms for the subsequent analyses.

Synthetic standards at different concentrations (0.5 ng/μl to 1 μg/μl) were then run to identify the peaks further and to quantify the areas for each compound; peaks are presented in terms of nanograms per hour per inflorescence (FIG. 18). Results were plotted and analyzed using a Non-metric multidimensional scaling (NMDS) analysis with a Wisconsin double standardization and square-root transformation of the emission rates and the Bray-Curtis dissimilarity index on the proportions using the vegan package in R (W. Takken, N. O. Verhulst, Host preferences of blood-feeding mosquitoes. Annual review of entomology 58, 433-453 (2013)). ANOSIM was performed on the data, which allowed for statistically examination of the differences in chemical composition and relative abundance between orchid species.

Mosquitoes Rearing and Colony Conditions

Field Mosquitoes.

Adult mosquitoes were caught by hand, using plastic containers (BioQuip® Products, Rancho Dominguez, Calif., USA), on the sites where the orchids were located. We also collected pupae in ponds located in the same areas. The mosquitoes were then brought back to the lab, maintained in cages (BioQuip® Products, Rancho Dominguez, Calif., USA) and placed in environmental chambers (22±1° C. during the day and 17±1° C. during the night, 60±10% relative humidity (RH) and with a 12-12 h light-dark cycle). There, they had access to 10% sucrose ad libitum. Before the experiments, the mosquitoes were starved for two days, CO₂ anesthetized (Flystuff Flypad, San Diego, Calif., USA) and identified using standard keys (F. Van Breugel, J. Riffell, A. Fairhall, M. H. Dickinson, Mosquitoes use vision to associate odor plumes with thermal targets. Current Biology 25, 2123-2129 (2015); W. A. Foster, Mosquito sugar feeding and reproductive energetics. Annual review of entomology 40, 443-474 (1995)). The taxonomic naming convention was used for classifying the field-caught mosquitoes (Manda, H., L. C. Gouagna, W. A. Foster, R. R. Jackson, J. C. Beier, J. I. Githure, and A. Hassanali, Effect of discriminative plant-sugar feeding on the survival and fecundity of Anopheles gambiae. Malaria journal, 2007. 6(1): p. 113). The mosquitoes bearing pollinia were snap-frozen in liquid nitrogen for further analyses.

Laboratory Mosquito Strains.

Female Ae. aegypti (wild type, MRA-734, ATCC®, Manassas, Va., USA) and An. stephensi (MRA-128, Strain STE2, CDC, Atlanta, Ga., USA) mosquitoes were also used for behavioral experiments. Mosquitoes were kept in an environmental chamber maintained at 25±1° C., 60±10% RH and under a 12-12 h light-dark cycle. Groups of 200 larvae were placed in 26×35×4 cm covered trays containing tap water and were fed daily on fish food (Hikari Tropic 382 First Bites—Petco, San Diego, Calif., USA). Groups of same age pupae (both males and females) were then isolated in 16 oz containers (Mosquito Breeder Jar, BioQuip® Products, Rancho Dominguez, Calif., USA) until emergence. Adults were then transferred into mating cages (BioQuip® Products, Rancho Dominguez, Calif., USA) and maintained on 10% sucrose. An artificial feeder (D. E. Lillie Glassblowers, Atlanta, Ga., USA; 2.5 cm internal diameter) filled with heparinized bovine blood (Lampire Biological Laboratories, Pipersville, Pa., USA) placed on the top of the cage was heated at 37° C. using a water-bath circulation system (HAAKE A10 and SC100, Thermo Scientific, Waltham, Mass., USA) and used to feed mosquitoes weekly. For the experiments, groups of 120 pupae were isolated and maintained in their container for 6 days after their emergence. Mosquitoes had access to 10% sucrose but were not blood-fed before the experiments. The day the experiments were conducted, mosquitoes were cold-anesthetized (using a climatic chamber at 10° C.) and females were selected manually with forceps.

Ae. aegypti PUb-GCaMP6s mosquitoes (U. S. Jhumur, S. Dötterl, A. Jürgens, Floral odors of Silene otites: their variability and attractiveness to mosquitoes. Journal of Chemical Ecology 34, 14 (2008)) used in the calcium imaging experiments were from the Liverpool strain, which was the source strain for the reference genome sequence. Briefly, this mosquito line was generated by injecting a construct that included the GCaMP6s plasmid (ID #106868) cloned into the piggyBac plasmid pBac-3×P3-dsRed and using Ae. aegypti polyubiquitin (PUb) promoter fragment. Mosquito pre-blastoderm stage embryos were injected with a mixture of the GCaMP6s plasmid described above (200 ng/ul) and a source of piggyBac transposase (phsp-Pbac, (200 ng/ul)). Injected embryos were hatched in deoxygenated water and surviving adults were placed into cages and screened for expected fluorescent markers. Mosquitoes were backcrossed for five generations to our wild-type stock, and subsequently screened and selected for at least 20 generations to obtain a near homozygous line. The location and orientation of the insertion site was confirmed by PCR.

All behavioral and physiological experiments were conducted at times when mosquitoes were the most active.

Gas Chromatography Coupled with Electroantennogram Detection (GC-EADs)

Electroantennogram signals were filtered and amplified (100×; 0.1-500 Hz) using an A-M 1800 amplifier (Sequim, Wash., USA) connected to a personal computer via a BNC-2090A analog-to-digital board (National Instruments, Austin, Tex., USA) and digitized at 20 Hz using WinEDR software (Strathclyde Electrophysiology Software, Glasgow, UK). A Hum Bug noise eliminator (Quest Scientific, Vancouver, Canada) was used to decrease electrical noise. The antennal responses to peaks eluting from the GC were measured for each mosquito preparation, and each peak and mosquito species. Bioactive peaks were those that elicited strong EAD responses, corresponding to deflections beyond the average noise floor of the baseline EAD signal. Responses by each individual preparation were used for Principal Component Analysis (Ade4 package, R). The responses of eight different mosquito species were tested to the scent extracts of three orchid species (n=8 mosquito species for P. obtusata; n=4 mosquito species each for P. stricta and P. huronensis; with 3-17 replicates per mosquito species per orchid, for a total of 109 GC-EAD experiments).

Preparation for Gas Chromatography Coupled with Electroantennogram Detection (GC-EADs).

Individual mosquitoes were isolated in Falcon™ tubes (Thermo Fisher Scientific, Pittsburgh, Pa., USA) covered with a piece of fine mesh. They were maintained in a climatic chamber, as previously described, and identified immediately before running the experiment. Carbon dioxide delivered through a pad (Genesee Scientific, San Diego, Calif., USA) was used to briefly anesthetize mosquitoes before transferring them on ice for the dissection. The head was excised and the tip (i.e., one segment) of each antenna was cut off with fine scissors under a binocular microscope (Carl Zeiss, Oberkochen, Germany). The head was then mounted on an electrode composed of a silver wire 0.01″ (A-M Systems, Carlsbord, Wash., USA) and a borosilicate pulled capillary (Sutter Instrument Company, Novato, Calif., USA) filled with a 1:3 mix of saline (L. B. Thien, F. Utech, The mode of pollination in Habenaria obtusata (Orchidaceae). American Journal of Botany 57, 1031-1035 (1970) and electrode gel (Parker Laboratories, Fairfield, N.J., USA) in order to avoid the preparation to desiccate during the experiment. The head was mounted by the neck on the reference electrode. The preparation was then moved to the GC-EAD with the tips of the antennae inserted under the microscope (Optiphot-2, Nikon, Tokyo, Japan) into a recording electrode, that was identical to the reference electrode. The mounted antennae were oriented at 90° from the main airline which was carrying filtered air (Praxair, Danbury, Conn., USA) and volatiles eluting from the Gas-Chromatograph to the preparation via a 200° C. transfer line (EC-05; Syntech GmbH, Buchenbach, Germany). Five microliters of the orchid extract were injected into the Gas Chromatograph with Flame Ionization Detection (Agilent 7820A GC, Agilent Technologies; DB5 column, J&W Scientific, Folsom, Calif., USA). The oven program was the same as the one used for the GC-MS analyses of the scent extracts. The transfer line from the GC to the preparation was set to 200° C.

Behavioral Experiments

Chemical Mixture Preparation and Single Odorants.

All the chemicals used for the behavioral experiments were ordered from Sigma Aldrich (St. Louis, Mo., USA)(≥98% purity) with the exception of the lilac aldehyde (mixture of B [49%], D [26%], and C [23%] isomers) that were synthesized by Medchem Source LLP (Seattle, Wash., USA) according to the methods of Wilkins et. al. (Nikbakhtzadeh, M. R., J. W. Terbot, P. E. Otienoburu, and W. A. Foster, Olfactory basis of floral preference of the malaria vector Anopheles gambiae (Diptera: Culicidae) among common African plants. Journal of Vector Ecology, 2014. 39(2): p. 372-383).

The ratio of D and C isomers approximated those quantified in the P. obtusata scent (FIG. 18). Briefly, linalool (0.5 mL) was aliquoted in dioxane (2 mL) and subsequently stirred with selenium dioxide (225 mg) under reflux for approximately 6 h. Afterward, the solution was separated using silica gel yielding 5-dimethyl-5-ethenyl-2-tetrahydrofuranacetaldehydes (lilac aldehyde, a mixture of isomers). Purity was verified by two-dimensional COSY NMR (AC-300, Bruker, Billerica, Mass.) and GC-MS (Agilent Technologies, Palo Alto, Calif., USA).

Stimuli included the scent from live P. obtusata flowers; an artificial mixture of the P. obtusata scent (with or without the lilac aldehyde); the lilac aldehyde at the concentration in the P. obtusata scent mixture; and the negative mineral oil (no odor) control. The artificial mixture was composed of a 14-component blend of odorants identified as antennal-active (via the GC-EAD experiments) (FIG. 18). The mixture was prepared by adding each synthetic component and adjusting so that the headspace concentrations matched those found in the P. obtusata floral headspace (as quantified through GC-MS). Briefly, emission rates of the artificial mixtures and single compounds were scaled to those of live flowers by their individual vapor pressures and associated partial pressures, and verified and adjusted by iterative headspace collection and quantification using the GC-MS.

To test the effects of different ratios of lilac aldehyde and nonanal in the orchid scents, mixtures were created where the composition and concentration of volatiles were the same as those in the P. obtusata scent, except the concentration of the lilac aldehyde was increased to similar levels as those measured in the scents of P. stricta, P. dilatata, and P. huronensis (FIG. 18). Similarly, in a different experimental series, mixtures were created where the composition and concentration of volatiles (including lilac aldehyde) were the same as those in the P. obtusata scent, except we decreased the concentration of nonanal to similar levels as those measured in the scents of P. stricta, P. dilatata, and P. huronensis (FIG. 18). Finally, higher tested concentrations of the P. obtusata mixture—well beyond those emitted naturally by P. obtusata plants—were significantly aversive to the mosquitoes (binomial tests: p<0.05).

Olfactometer. Female Ae. aegypti (MRA-734; n=874 tested and flew; n=622 made a choice) and An. stephensi (MRA-128; n=153 tested and flew; n=73 made a choice) from laboratory colonies, and Ae. increpitus and Ae. communis caught in the field (n=138 tested), were used for these experiments. Female mosquitoes were individually selected and checked for the integrity of their legs and wings to ensure that they would be able to behave properly in the olfactometer. Females were then individually placed in 50 mL conical Falcon™ tubes (Thermo Fisher Scientific, Pittsburgh, Pa., USA) covered by a piece of mesh maintained by a rubber band. All behavioral experiments were conducted at times of the day when mosquitoes were the most active over the course of a 1.5 h period.

A custom-made Y-maze olfactometer made from Plexiglas® was used to compare the behavioral response of the mosquitoes to different odor stimuli. The olfactometer is comprised of a starting chamber where the mosquitoes were released, a tube (length: 30 cm; diameter 10 cm) connected to a central box where two choice arms of equal length (39 cm) and diameter (10 cm) were attached. Fans (Rosewill, Los Angeles, Calif., USA) placed inside a Plexiglas® box were connected to the two arms of the olfactometer. The fans generate airflows of 20 cm/s. The air first passes through a charcoal filter (C16×48, Complete Filtration Services, Greenville, N.C., USA) to remove any odor contaminants that may be in the ambient air. The filtered air then passes through a mesh screen and an aluminum honeycomb core (10 cm in thickness) to create a laminar flow within the olfactometer. Odor delivery to each choice arm is made using an aquarium pump adjusted with flow meters (Cole-Parmer, Vernon Hills, Ill., USA). Air lines (Teflon® tubing; 3 mm internal diameter) were connected to one of two 20 mL scintillation vials containing the odor stimulus or control (mineral oil). Odor stimuli were deposited on Whatman® Grade 1 Filter Paper (32 mm diameter, VWR International, Radnor, Pa. USA) cut into strips (1 cm×5 cm). Each line was connected to the corresponding choice arm of the olfactometer and placed at about 4 cm from the fans so that the tip of the tubing was centered in the airflow generated by the fans, and flow through the tubes was approximately 5 mL/min. To prevent odor concentrations from decreasing during the experiment, odor-laden filter papers were replaced every 20 to 25 minutes. Concentrations at the beginning and end of the 25 minute period (verified by Solid-Phase Microextraction fiber collections, each for 5 minutes, and subsequently run on the GCMS) showed no significant difference in emissions (t test: p=0.45). Over each 25 minute period, approximately 5 mosquitoes were tested, and the total length of an experiment (during a single day) was approximately 1.5 h. All the olfactometer experiments were conducted in a well-ventilated environmental chamber (Environmental Structures, Colorado Springs, Colo., USA) maintained at 25° C. and 50-70% RH. After each experiment, the olfactometer, tubing, and vials were sequentially cleaned with 70% and 95% ethanol and dried overnight to avoid any contamination between experiments. Finally, to control for any directional biases, the control- and odor-bearing arms of the olfactometer were randomized between experiments. A Logitech C615 webcam (Logitech® Newark, Calif., USA) mounted on a tripod and placed above the olfactometer was used to record the mosquito activity during the entire experiment.

The experiment began when one single mosquito was placed in the starting chamber. The mosquito then flew along the entry tube and, at the central chamber, could choose to enter one of the olfactometer arms, one emitting the odor and the other the “clean air” (solvent only) control (N. Brantjes, J. Leemans, Silene otites (Caryophyllaceae) pollinated by nocturnal Lepidoptera and mosquitoes. Acta botanica neerlandica 25, 281-295 (1976). The first choice made by mosquitoes was considered to be when they crossed the entry of an arm. Mosquitoes that did not choose or did not leave the starting chamber were considered as not responsive and discarded from the preference analyses. In addition, to ensure that contamination did not occur in the olfactometer and to test mosquitos' responses to innately attractive, mosquitoes were placed in the olfactometer and exposed to either two clean air currents (neutral control). Overall, approximately 60-70% of the females were motivated to leave the starting chamber of the olfactometer and choose between the two choice arms.

Binary data collected in the olfactometer were analyzed and all statistical tests were computed using R software (R Development Core Team (Nyasembe, V. O., & Torto, B. (2014). Volatile phytochemicals as mosquito semiochemicals. Phytochemistry letters, 8, 196-201)). Comparisons were performed by means of the Exact Binomial test (α=0.05). For each treatment, the choice of the mosquitoes in the olfactometer was either compared to a random distribution of 50% on each arm of the maze or to the distribution of the corresponding control when appropriate. For binary data, the standard errors (SE) were calculated as in N. Brantjes, J. Leemans, Silene otites (Caryophyllaceae) pollinated by nocturnal Lepidoptera and mosquitoes. Acta botanica neerlandica 25, 281-295 (1976):

$$SEM = {( \frac{p ( 1 - p )}{n} )}^{\frac{1}{2}}$$

For each experimental group, a preference index (PI) was computed in the following way: PI=[(number of females in the test arm−number of females in the control arm)/(number of females in the control arm+number of females in the test arm)]. A PI of +1 indicates that all the mosquitoes chose the test arm, a PI of 0 indicates that 50% of insects chose the test arm and 50% the control arm, and a PI of −1 indicates that all insects chose the control arm of the olfactometer (N. Brantjes, J. Leemans, Silene otites (Caryophyllaceae) pollinated by nocturnal Lepidoptera and mosquitoes. Acta botanica neerlandica 25, 281-295 (1976)).

Two-Photon Excitation Microscopy

Calcium Imaging in the Ae. Increpitus Mosquito AL.

Odor-evoked responses in the Ae. increpitus mosquito antennal lobe (AL) with nine female mosquitoes at the beginning of the season when mosquitoes were relatively young (as defined by wing and scale appearance). Calcium imaging experiments were conducted using application of the calcium indicator Fluo4 to the mosquito brain and using a stage that allows simultaneous calcium imaging and tethered flight. The mosquito was cooled on ice and transferred to a Peltier-cooled holder that enables the mosquito to head to be fixed to the stage using ultraviolet glue. The custom stage permits the superfusion of saline to the head capsule and space for movement by the wings and proboscis. Once the mosquito was fixed to the stage, a window in its head was cut to expose the brain, and the brain was continuously superfused with physiological saline. Next, the perineural sheath was gently removed from the AL using fine forceps and 75 μL of the Fluo4 solution—made by 50 mg of Fluo4 in 30 μL Pluronic F-127 and then subsequently diluted in 950 μL of mosquito physiological saline—was pipetted to the holder allowing the brain to be completely immersed in the dye. Mosquitoes were kept in the dark at 15° C. for 1.5 h (the appropriate time for adequate penetration of the dye into the tissue), after which the brain was washed 3 times with physiological saline. After the rinse, mosquitoes were kept in the dark at room temperature for approximately 10-20 min. before imaging.

Wing stroke amplitudes were acquired and analyzed using a custom camera-based computer vision system at frame rates of 100 Hz, where the mosquito was illuminated with infrared LEDs (880 nm) and images were collected with an infrared-sensitive camera synched to the two-photon system. Stimulus-evoked initiation of flight and changes in the amplitude of the wing-stroke envelope were characterized for each odor stimulus. Calcium-evoked responses in the AL were imaged using the Prairie Ultima IV two-photon excitation microscope (Prairie Technologies) and Ti-Sapphire laser (Chameleon Ultra; Coherent). Experiments were performed at a depth of 40 μm from the ventral surface of the AL, allowing the calcium dynamics from approximately 18-22 glomeruli to be repeatedly imaged across preparations. Images were collected at 2 Hz, and for each odor stimulus images were acquired for 35 s, starting 10 s before the stimulus onset. Imaging data were extracted in Fiji/ImageJ and imported into Matlab (v2017; Mathworks, Natick, Mass.) for Gaussian filtering (2×2 pixel; σ=1.5-3) and alignment using a single frame as the reference at a given imaging depth and subsequently registered to every frame to within ¼ pixel. Trigger-averaged ΔF/F was used for comparing glomerular responses between odor stimuli. After an experiment, the AL was sequentially scanned at 1 μm depths from the ventral to dorsal surface. Ventral glomeruli to the 40 μm depth were 3D reconstructed using Reconstruct software or Amira v5 (Indeed-Visual Concepts, Houston Tex., USA) to provide glomerular assignment and registration between preparations. Glomeruli in the ventral region of the AL, based on their positions, were tentatively assigned names similar to those in Ae. aegypti.

Calcium Imaging in the Ae. Aegypti Mosquito AL.

Odor-evoked responses in the Ae. aegypti AL were imaged taking advantage of a genetically-encoded PUb-GCaMPs mosquito line (M. Bui et al., Live calcium imaging of Aedes aegypti neuronal tissues reveals differential importance of chemosensory systems for life-history-specific foraging strategies. BMC Neuroscience, 20, 1-17 (2019)). A total of twenty preparations were used: 10 for single odorant and orchid mixture experiments; 6 for ratio experiments; and 4 for experiments using GABA-receptor antagonists. Glomeruli were imaged at 40 μm from the ventral surface, as glomeruli at this depth show strong responses to odorants in the orchid headspace, including nonanal, octanal, and lilac aldehyde, and at this depth, approximately 14-18 glomeruli can be neuroanatomically identified and registered between preparations. The expression of GCaMP occurred in glia, local interneurons, and projection neurons. Nevertheless, double-labeling for GFP (GCaMPs) and glutamine synthase (GS; glial marker) revealed broad GFP labeling that did not always overlap with the glial stain, with GS-staining often occurring on astroglial-like processes on the rind around glomeruli, and strong GFP occurring within the glomeruli. Thus, in the calcium imaging experiments care was taken to image from the central regions of the glomeruli and avoid the sheaths and external glomerular loci. Moreover, strong GFP staining occurred in soma membranes located in the medial and lateral cell clusters, which contain the projection neurons and GABAergic local interneurons, respectively; the vast majority of these cell bodies did not stain for GS. Relatedly, GCaMP6s expression is very high in AL local interneurons and projection neurons (PNs), such that during odor stimulation the PNs and axonal processes can often be imaged, and 3D reconstructions can be take place through simultaneous optical sections with odor stimulation. Nonetheless, the glomerular responses were assumed to be a function of multiple cell types. In other insects, GABAergic modulation has been shown to operate on olfactory receptor neurons, local interneurons and PNs.

Similar to experiments with Ae. increpitus, the majority the mosquitoes were UV-glued to the stage to allow free movement of their wings and proboscis; however, for experiments using GABA-receptor antagonists the proboscis was glued to the stage for additional stability. Once the mosquito was fixed to the stage, a window in its head was cut to expose the brain, and the brain was continuously superfused with physiological saline.

Glomerular Registration from Two Photon Experiments.

Glomeruli were initially attempted to be registered using a previously published AL atlas (Inouye, D. W., 2010. Mosquitoes: more likely nectar thieves than pollinators. Nature, 467(7311), p. 27) but the number, position and size of glomeruli from imaging experiments did not always match those of the previous study. Thus a provisional atlas was created with female mosquitoes (n=6) that allowed for cross-reference of the imaged glomeruli and comparison of their positions and structures to those described in the atlas. This was accomplished via clear glomerular boundaries, especially during odor stimulation, and the distinct odorant tuning of glomeruli throughout the depths of the AL (e.g., AM2 responsive to DEET; LC2 and AL3 responsive to nonanal; PD3 responsive to geosmin; and MD2 responsive to CO₂) that allowed 3D registration across preparations and subsequent warping and referencing with the atlas. Based on these results glomerular names were tentatively assigned.

Saline and pharmacological agents. The saline was made based on the Beyenbach and Masia recipe (L. B. Thien, F. Utech, The mode of pollination in Habenaria obtusata (Orchidaceae). American Journal of Botany 57, 1031-1035 (1970)) and contained 150.0 mM NaCl, 25.0 mM N-2-hydroxyethyl-piperazine-N′-2-ethanesulfonic acid (HEPES), 5.0 mM sucrose, 3.4 mM KCl, 1.8 mM NaHCO₃, 1.7 mM CaCl2, and 1.0 mM MgCl₂. The pH was adjusted to 7 with 1 M NaOH. Immediately before the experiment, GABA receptor antagonists were dissolved in saline (1 μM Picrotoxin (Sigma-Aldrich, St. Louis, Mo.; P1675), and 10 μM CGP54626 (Tocris Bioscience, Park Ellisville, Mo.; CGP 54626); to block both GABA-A and GABA-B receptors). A drip system comprising two 100 mL reservoirs—one containing the GABA receptor antagonists, and the other saline—converged on the two-channel temperature controller to facilitate rapid switching from normal physiological saline solution to the antagonists and back. Antagonists were superfused directly into the holder near to the opening of the head capsule and recorded neuropil. The odor-evoked responses were first recorded under normal physiological saline solution and then repeated under GABA receptor antagonists diluted in normal saline solution, and finally the normal saline wash. All calcium imaging data were statistically analyzed using Kruskal-Wallis tests with multiple comparisons and visualized using Principal Components Analysis. Analyses were performed in Matlab (v2017; Mathworks, Natick, Mass.).

Olfactory Delivery and Stimuli.

Olfactory stimuli were delivered to the mosquito by pulses of air diverted through a 2 mL cartridge containing a piece of filter paper bearing the odor stimulus (2 An air line provided gentle and constant charcoal-filtered air at 1 m/s to the antennae allowing continuous ventilation to prevent adaptation of the olfactory receptor cells. The stimulus output was positioned in the air line 2 cm from and orthogonal to the mosquito antennae. For testing different ratios of lilac aldehyde and nonanal, two syringes bearing different concentrations of the odorants were used and positioned such that the outputs were positioned in the same location in the air stream. Pulses of odor, each at a duration of two seconds and at a flow rate of approximately 5 ml/min., were delivered to the antennae using a solenoid-activated valve (The Lee Company, Essex, Conn., USA, LHDA0533115H) controlled by the PrairieView software. Odor stimuli were separated by intervals of 120 s to avoid receptor adaptation. The two-way valve enabled a constant airstream with minimal disturbance during odor stimulation. Odorants (>98% purity; Sigma-Aldrich, St. Louis, Mo., USA) were diluted in mineral oil to scale the intensities to those quantified in the P. obtusata scent, except for DEET (N,N-diethyl-meta-toluamide)(1-40% concentrations) which was diluted in 200 proof ethanol, and each cartridge used for no more than 4 stimulations. Olfactory stimuli were: aliphatics (nonanal [220 ng], octanal 46 ng], hexanal [9 ng], 1-octanol [0.5 ng]); monoterpenes (α-pinene [1.44 ng], β-pinene [1.5 ng], camphene [1.41 ng], β-myrcene [3.5 ng], D-limonene [16.5 ng], eucalyptol [3.4 ng], lilac aldehyde (B, C and D isomers) [124.7 ng], (±)linalool [1.41 ng], and myrtenol [1.35 ng]); aromatics (benzaldehyde [1.45 ng], DEET [10%]); and mixtures, including human scent, the P. obtusata mixture, the P. stricta mixture, the P. dilatata mixture, and the P. huronensis mixture. Similar to behavioral experiments, for experiments examining the effects of lilac aldehyde in the flower mixtures (FIGS. 12A-12D, 13A, and 13B), the odor constituents were kept the same except for lilac aldehyde which was scaled to the headspace concentrations of P. strica, P. huronensis, or P. dilatata. This provided a mechanism to determine how the change of one odorant concentration in the mixture impacted the activation or suppression of glomeruli in the ensemble. Importantly, all odorant constituents and floral mixtures were at the same headspace concentration levels as the natural floral scents or scent constituents, as verified by headspace collections and quantification using the GC-MS.

Human scent samples were collected by gently rubbing Whatman filter paper on the ankles and wrists of one human volunteer per experiment. Prior to human scent collection, volunteers placed their ankles and wrists over running water for ten minutes. The human scent protocols were reviewed and approved by the University of Washington Institutional Review Board, and all volunteers gave their informed consent to participate in the research. Control solvents for the olfactory stimuli were mineral oil (for the majority of odorants and mixtures) and ethanol (for DEET).

Immunohistochemistry

To register putative glomeruli in our calcium imaging experiments, an AL atlas was created using antiserum against tyrosine hydroxylase (ImmunoStar, Hudson, Wis., USA—Cat. no. 22941; 1:50 concentration), GABA (Sigma-Aldrich, St. Louis, Mo., USA—Cat. no. A2052; 1:100 concentration) and monoclonal antisera against alpha-tubulin (12G10; 1:1000 concentration; developed by Drs. J. Frankel and E. M. Nelsen). In addition, to characterize the expression of GCaMP in different cell types in the AL, the cells were double-stained for GFP (for the GCaMP6s; Abcam, Cambridge, Mass., USA—Cat. no. ab6556; 1:1000 concentration) and glutamine synthase (GS; a glial marker; Sigma-Aldrich, St. Louis, Mo., USA—Cat. no. MAB302; 1:500 concentration); and GABA and GS. The alpha-tubulin antiserum was obtained from the Developmental Studies Hybridoma Bank developed under the auspices of the NICHD and maintained by the University of Iowa, Department of Biology (Iowa City, Iowa). These antisera either provide clear designation of glomerular boundaries, allowing 3D reconstruction of individual glomeruli, or designation of glial-, GABA-, and GFP-stained cells and processes. Briefly, animals were immobilized by refrigeration at 4° C. and heads were removed into cold (4° C.) fixative containing 4% paraformaldehyde in phosphate-buffered saline, pH 7.4 (PBS, Sigma-Aldrich, St. Louis, Mo., USA—Cat. No. P4417). Heads were fixed for 1 h and then brains were dissected free in PBS containing 4% Triton X-100 (PBS-TX; Sigma-Aldrich, St. Louis, Mo., USA—Cat. No. X100). Brains were incubated overnight at 4° C. in 4% PBS-TX. Brains were washed three times over 10 minutes each in 0.5% PBS-TX and then embedded in agarose. The embedded tissue was cut into 60 μm serial sections using a Vibratome and washed in PBS containing 0.5% PBS-TX six times over 20 minutes. Then 50 μL normal serum was added to each well containing 1,000 μL PBS-TX. After 1 hour, the primary antibody was added to each well and the well plate was left on a shaker overnight at room temperature. The next day, sections were washed six times over 3 h in PBS-TX. Then 1,000-μL aliquots of PBS-TX were placed in tubes with 2.5 μL of secondary Alexa Fluor 488 or Alexa Fluor 546-conjugated IgGs (ThermoFisher Scientific, Waltham, Mass., USA) and centrifuged at 13,000 rpm for 15 minutes. A 900-4, aliquot of this solution was added to each well, and tissue sections were then washed in PBS six times over 3 h, embedded on glass slides in Vectashield (Vector Laboratories, Burlingame, Calif., USA—Cat. No. H-1000) and imaged using a Leica SP5 laser scanning confocal microscope. Images were processed using ImageJ (National Institutes of Health) and a 3D atlas, assembled from 6 mosquitoes, were constructed using the Reconstruct software (v. 1.1.0.0) (Stoutamire, W. P., Mosquito pollination of Habenaria obtusata (Orchidaceae). Mich. Bot, 1968. 7: p. 203-212).

While illustrative embodiments have been illustrated and described, it will be appreciated that various changes can be made therein without departing from the spirit and scope of the invention.

1. A composition, comprising:
(a) nonanal, and
(b) lilac aldehydes,
wherein the ratio of nonanal to lilac aldehydes is from about 1:1 to about 100:1 by weight based on the total weight of nonanal and lilac aldehydes.

2. A composition, comprising:
(a) nonanal,
(b) lilac aldehydes, and
(c) a solvent carrier.

3. A composition, comprising:
(a) nonanal,
(b) lilac aldehydes, and
(c) a substrate.

4. The composition of claim 1, wherein the lilac aldehydes are a mixture of lilac aldehyde B, lilac aldehyde C, and lilac aldehyde D.

5. The composition of claim 1 further comprising one or more of heptanal, octanal, 1-octanol, α-pinene, camphene, β-pinene, β-myrcene, D-limonene, eucalyptol, linalool, myrtenol, and benzaldehyde.

6. The composition of claim 1 further comprising octanal.

7. The composition of claim 1 further comprising octanal, 1-octanol, and (R,S)-linalool.

8. The composition of claim 1 further comprising octanal, 1-octanol, (R,S)-linalool, myrtenol, benzaldehyde, α-pinene, camphene, and eucalyptol.

9. The composition of claim 1 further comprising heptanal, octanal, 1-octanol, α-pinene, camphene, β-pinene, β-myrcene, D-limonene, eucalyptol, linalool, myrtenol, and benzaldehyde.

10-15. (canceled)

16. The composition of claim 1, wherein the ratio of nonanal to lilac aldehydes is about 100:1 based on the amount (mass) of nonanal and lilac aldehydes in the composition.

17. The composition of claim 1, wherein the ratio of nonanal to lilac aldehydes is about 1:1 based on the amount (mass) of nonanal and lilac aldehydes in the composition.

18. The composition of claim 1, wherein the ratio of lilac aldehydes to nonanal is about 6:1 based on the amount (mass) of lilac aldehydes and nonanal in the composition.

19. (canceled)

20. A method for attracting a mosquito to a pre-determined location, comprising positioning a composition of claim 1 at the pre-determined location.

21. The method of claim 20, wherein the pre-determined location is a mosquito breeding area.

22. The method of claim 20, wherein the mosquito is a male or female mosquito of the species Aedes aegypti, Anopheles stephensi, Culex quinquefasciatus, Aedess communis, Aedes increpitus, and Aedes canadensis.

23. (canceled)

24. A method for repelling a mosquito from a pre-determined location, comprising positioning a composition of claim 18 at the pre-determined location.

25. The method of claim 24, wherein the pre-determined location is a mosquito breeding area.

26. The method of claim 24, wherein the mosquito is a male or female mosquito of the species Aedes aegypti, Anopheles stephensi, Culex quinquefasciatus, Aedess communis, Aedes increpitus, and Aedes canadensis.

27. A dispenser for attracting mosquitoes, comprising a housing containing a composition of claim 1, wherein the housing is adapted to release the composition over time into an environment in the vicinity of the dispenser.

28. A dispenser for repelling mosquitoes, comprising a housing containing a composition of claim 18, wherein the housing is adapted to release the composition over time into an environment in the vicinity of the dispenser.
